(19) United States
(12) Patent Application Publication
(10) Pub. No.: US 2015/0244751 A1
(43) Pub. Date: Aug. 27, 2015

(54) APPARATUS AND METHOD FOR RELAYING DATA OF A MEDIA CONTENT OF WHICH SECTION INFORMATION IS CARRIED BY LIST INFORMATION

(71) Applicant: AIRPLUG INC., Seoul (KR)

(72) Inventors: Seung Jun Lee, Seoul (KR); Soon Uk Kim, Anyang-si (KR); Sung Moon Shin, Seoul (KR)

(21) Appl. No.: 14/424,028

(22) PCT Filed: Aug. 12, 2013
(86) PCT No.: PCT/KR2013/007231

§ 371 Date: Feb. 25, 2015

(30) Foreign Application Priority Data
Sep. 7, 2012 (KR) 10-2012-0099339

(51) Int. Cl. H04L 29/06; H04L 29/08

(52) U.S. Cl. CPC H04L 65/4069; H04L 65/601; H04L 67/1097

(57) ABSTRACT

A terminal according to the present invention comprises a relaying unit. The relaying unit requests list information of sections to a remote site with respect to a content selected by an arbitrary entity and receives it therefrom. Then, the relaying unit receives sections pertaining to the content by requesting them to a remote site with reference to information included in the received list information. When a request for list information of the content is received from another entity, the relaying unit draws up list information for sections listed in the received list information and provides it to the another entity as a response to the received request. While drawing up the list information, the relaying unit changes remote source information about an arbitrary section listed in the received list information to local source information including a pathname assigned to a repository allocated for storing data of the arbitrary section.

### TECHNICAL FIELD

The present invention relates to an apparatus and method of receiving a media content from a remote site through networks, especially wireless networks, and relaying data of the content being received to other entity, for example, a media player being executed in a terminal so that the relayed data may be played thereby.

### BACKGROUND ART

As mobile communication networks are advanced, users are now able to search for various kinds of needed information through browsing, and view desired media contents after download or in a streaming way regardless of their current location by using a wireless terminal such as a smart phone, a tablet computer, and the like, not to mention a mobile phone.

In addition, as the performance of a radio communication infrastructure and a wireless terminal is further improved, a variety of media contents, e.g., live sports broadcasts, news, music show and so on are being provided even live these days, for example, in compliance with HLS (HTTP Live Streaming) communication protocol. In case a live media content is selected, media index information 1 similar as illustrated in FIG. 1 containing a list of components 1a, 1b, which are mutually different in quality or bitrate, etc. and can be provided by a server for a selected content, is transmitted to a wireless terminal first by the server. Afterwards, if one component 1b is chosen from the list at the wireless terminal, the server transmits segment list information 2 illustrated in FIG. 2, which information (URLs 2a associated individually with corresponding segment files, playback duration 2b of each segment, and so on) about content segments providable at present for the chosen component 1b is included in, to the wireless terminal. The content segments are sequentially demanded on the basis of the segment list information 2 by the wireless terminal. The data of each content segment received in response to the sequential demands is decoded so that the selected content is played on the wireless terminal.

The media players capable of playing the live media content, e.g., live video content provided as explained above can be obtained in general from an on-lined market server, etc. so that a user selects a desired media player on the market server and downloads it to be installed into his or her own wireless terminal. After installation, a user executes the player whenever he or she wants. Typically, such media players is designed to utilize functions (e.g., connection release of currently-used network, or notification of connection to a new network, etc.) supported by a base system (e.g., O/S, or platform, etc.) embedded in a wireless terminal in order to conduct its own function, for example, decoding media data received through a network.

When it is intended that an additional function is to be embedded into a media player or an existing function thereof is to be improved for user's convenience or better performance, the base system must be able to support the additional or improved function because such function is generally based on basic functions of an O/S, a platform and so on. That is, addition of a new function into a media player or improvement of function already embedded therein is subject to the base system of a wireless terminals. By the way, it usually takes long time to upgrade the base system for expanding its basic functions or upgrade of the base system may be stopped. Thus, improving a media player would be difficult for the functions that are based on the base system.

Furthermore, because the wireless terminal manufacturers are adopting slightly different base systems to their wireless terminals, development or improvement of a media player may be to be made differently depending on terminal manufacturers. And, in that development or improvement, a part of functions of a media player may not be implementable for wireless terminals of a certain manufacturer. Because of such not-unified environment, the cost of maintaining or improving a content providing service would increase unnecessarily from standpoint of the service providers who provide media contents to wireless terminals through networks.

Considering the above-mentioned environments, it would be beneficial in many aspects to provide, by way of a single execution entity (e.g., application or process), the parts of the base system embedded in a wireless terminal that are used by a media player to practice its own functions because improving functions of the execution entity can be made easily and continuedly and thus adding a new function into a media player or improving functions thereof can be made easily based on the execution entity. In addition, developing or improving a media player would be possible even less taking into account the factors of characteristics of terminal manufacturers, the types of terminals, and so on.

### DISCLOSURE

### Problem to be Solved

One object of the present invention is to provide method and apparatus for relaying to an execution entity data of a media content being received from a remote site with reference to section information that is provided continuedly for the media content wherein the execution entity is executable independently of another execution entity for decoding the media content.

Another object of the present invention is to provide method and apparatus for having a media content received adaptively according to communication state in which data is being received in order that an execution entity for decoding the media content may play data of the media content reliably or optimally irrespective of changes in communication state, etc.

The scope of the present invention is not necessarily limited to the above explicit statements. Rather, the scope of the present invention covers anything to accomplish effects that could be derived from the specific and illustrative explanations of the present invention below.

### Technical Solution

A terminal being capable of receiving data of a media content through a wireless network in accordance with an aspect of the present invention, comprises: a transceiver configured to transceive data to/from an external server through a wireless network; a storage unit configured to store data of a media content received from a remote site through the transceiver; and a controller that is configured to: request list information of content sections through the transceiver and receive the list information from a remote site, the content sections pertaining to a media content selected by an arbitrary entity being executed in the terminal; request sections of the selected media content based on the received list information and store the requested sections in the storage unit while receiving the sections from a remote site through the transceiver; and prepare list information for all or a part of content sections listed in the received list information, if a request for list information is received from another entity with respect to the selected media content, and provide the prepared list information to the another entity as a response to the received request. Further, when preparing the list information from information included in the received list information in, the controller changes remote source information about a content section listed in the received list information to local source information including a file pathname assigned to a repository allocated for storing data of the content section in the storage unit.

In one embodiment according to the present invention, the controller is configured to change the remote source information to local source information in which information to identify, based on IP address system, an entity being executed in the terminal is located before a file pathname. In the present embodiment, the terminal further comprises a delivering unit configured to: read data stored in a specific repository if a request for a content section based on IP address system is received from the another entity, the specific repository being identified by a pathname of file included in the request for a content section or by repository information associated with the file pathname; incorporate the read data into a response to the received request for a content section; and provide the response to the another entity. The delivering unit may be integrated into the controller. In the present embodiment, the file pathname assigned to the repository may be a pathname to uniquely identify the repository under file system that works in the terminal, or a pathname that is assigned pursuant to the file system but does not indicate the repository directly.

In another embodiment according to the present invention, the controller is configured to change the remote source information to local source information including: information to uniquely identify, under file system that works in the terminal, a file of content section allocated in the storage unit and to direct access of the file; or information to indicate a repository of content section under a pre-specified rule and information to specify that the local source information is pursuant to the pre-specified rule.

In one embodiment according to the present invention, a request for the selected media content is delivered from the arbitrary entity to the controller through a local socket of which destination is set to an internal address. And the local socket is created according to the request for the selected media content in such a manner that destination thereof is set to the internal address, irrespective of destination address written in the request for the selected media content, that is registered in proxy information configured for the terminal. In the present embodiment, the proxy information is set by execution of a process including the controller, and the internal address indicates the controller or the process under IP address system.

In one embodiment according to the present invention, the controller is configured to receive list information for content sections through successive requests or only single request with respect to each of components of mutually different qualities of attributes that belong to the selected media content. Further, the controller is also configured to change from a component being currently received to another component for the selected media content, if a specific condition is satisfied, and receive content sections pertaining to the changed another component. In the present embodiment, even if list information for a component initially chosen for the selected media content is requested from the another entity after the component change the controller prepares new list information to include local source information for content sections that are received for the another component, and provides the new list information to the another entity in response to the list information request after the component change. Herein, the specific condition includes at least one of: a condition that a type of a wireless network to which the wireless terminal is connected corresponds to a predetermined particular type of network; a condition that network change is made between networks that charge different data service fee each other on premise of same amount of data usage; a condition that a ratio of demanding speed of a component being currently received to receiving bandwidth supported by current communication state is greater than a first reference or smaller than a second reference; a condition that an amount of data used with respect to a particular wireless network through the terminal or on behalf of a subscriber of the terminal exceeds a preset amount of data; and a condition that control information to restrict using a particular wireless network is received from an outside.

In one embodiment according to the present invention, wherein the controller is further configured to: relay a request for the selected media content from the arbitrary entity to a remote site through the transceiver; select a single component from among a plurality of components listed in media index information that is received through the transceiver from the remote site in response to the relayed request; prepare media index information to list the selected single component and provide the prepared media index information for the arbitrary entity or the another entity. In the present embodiment, the controller conducts, if a pre-specified information directs selection of a single component, selection of a single component and preparation of media index information for the selected single component, and provides, otherwise, the received media index information in which a plurality of components are listed. Further, the controller selects the single component from among a plurality of components based on the type of wireless network that is currently connected to the terminal.

In one embodiment according to the present invention, the controller may conduct an operation for switching connection of the terminal to another wireless network to be used by the transceiver, or for changing wireless network usage of the transceiver from single network to multiple networks. In the present embodiment, the controller may switch connection of the terminal to the another wireless network in case bit rate of a media content is to be lowered. In addition, in case information to limit a traffic load applied to a wireless network being currently used by the terminal is received from an outside, the controller switches connection of the terminal to the another wireless network if the another wireless network is connectable, and lowers bit rate of the media content being received from the remote site before requesting sections of the media content if not connectable.

In one embodiment according to the present invention, the controller is configured to: prepare one or more pieces of list information by modifying information about content sections listed in the received list information; and provide the prepared one or more pieces of list information individually in response to a list information request from the another entity, wherein in providing the prepared one or more pieces of list information, the controller omits information about at least one content section listed in the received list information not to be provided to the another entity, replaces the information about the at lease one content section with information about another media object, or adds the information about the another media object into the prepared list information. In the present embodiment, the controller conducts the omitting or the replacing based on a result of comparing receiving bandwidth pursuant to current communication state with demanding speed of content sections being currently received or based on a state in which a response to a content section request pursuant to list information provided to the another entity is delivered to the another entity.

In addition, the controller may determine, based on how much playing the media content will be delayed due to the another media object, whether to replace the information about the at lease one content section with the information about the another media object or to add the information about the another media object into the prepared list information. The controller inserts information indicating discontinuity of encoding time information into data of a content section associated with information listed next to information about the another media object in list information that is provided as a response to the another entity.

In one embodiment according to the present invention, the controller is configured to list a content section, whose data is all stored in the storage unit after being requested to the remote site based on the received list information, in list information to be provided to the another entity as a response.

In one embodiment according to the present invention, the selected media content is a live media content having a data section whose data is created in real time. Alternatively, the selected media content may be the VOD-typed media content of which every section is already prepared with its data.

In one embodiment according to the present invention, the controller incorporates a client identification, for example, an identification of a terminal, a subscriber of the terminal or an execution entity within the terminal into a request that is transmitted to demand list information of content sections pertaining to the selected media content.

In one embodiment according to the present invention, both the another entity and the arbitrary entity are same entity.

In another embodiment according to the present invention, both the another entity and the arbitrary entity may be separate entities that are executable independently each other. In this case, the controller is configured to request the selected media content to a remote site according to information carried by a request for the selected media content received from the arbitrary entity; receive a response including information about at least one component pertaining to the requested media content; and provide the received response including the information about the at least one component as a response to a request for the selected media content received from the another entity.

A method for relaying a media content by way of section list information in accordance with another aspect of the present invention, comprises: receiving information about a media content selected by an arbitrary entity being executed in the terminal; requesting list information of content sections pertaining to the selected media content based on the received information about the media content, and receiving the requested list information through a wireless network; and conducting a first operation for obtaining a content section listed in the received list information from an external server and a second operation for providing list information drawn up based on the received list information to another entity. In the method, the first operation comprises: requesting, with reference to remote source information on a content section listed in the received list information, the external server to transmit the content section; and storing data of the content section that is received accordingly, and the second operation comprises: drawing up list information for all or a part of content sections listed in the received list information according to a request for list information received from the another entity with respect to the selected media content; and providing the drawn-up list information to the another entity as a response to the request received from the another entity wherein the list information is drawn up in such a manner that remote source information about an arbitrary content section listed in the received list information is changed to local source information including a file pathname assigned to a repository allocated for the arbitrary content section.

An apparatus for providing a program stored in a storage in accordance with another aspect of the present invention, comprises: communication means being capable of transceiving data with an outside entity; and a storing unit storing an application, to be run on a wireless terminal, that is transmitted through the communication means. And, the application includes program structures to accomplish functions, in case of being run on the wireless terminal, that comprise: a first function of requesting list information of content sections pertaining to a media content, selected by an arbitrary entity being executed in the wireless terminal, to an external server and receiving the list information therefrom; a second function of requesting, based on information about a content section listed in the received list information, content sections to an external server and storing the content sections received therefrom as individual files; a third function of preparing list information for all or a part of content sections listed in the received list information if a request for list information is received from another entity with respect to the selected media content, and providing the prepared list information to the another entity as a response to the received request, wherein the list information is prepared in the third function in such a manner that remote source information about an arbitrary content section listed in the received list information is changed to local source information including a file pathname assigned to a repository allocated for the arbitrary content section.

### Advantageous Effects

According to the above-explained present invention or at least one embodiment of the present invention to be explained in detail later in reference to the accompanied drawings, even though an execution entity for decoding and playing data of a media content does not intervene in adaptive quality change depending on communication state or appropriate switching between or co-using networks, such operations are conducted properly in the data relaying process. As a result, the execution entity for playing a media content can take various benefits, for example, stable data reception in disregard of network state, adaptive quality change of a media content depending on communication bandwidth, or minimization of service fee to be charged for using a network, etc. although it simply conducts only operation of obtaining and decoding data with reference to the provided information about sections of a media content.

Furthermore, in the event that a plurality of media decoding entities are equipped in a wireless terminal in preparation for various encoding formats of arbitrary media contents, if a relaying entity being capable of relaying data of a media content to those entities in accordance with the present invention implements additional or improved functions, all of the media decoding entities are able to utilize those functions. Needless to say, those additional or improved functions can be utilized without any modification or upgrade of the media decoding entities. If a carrier to operate wireless communication networks controls the relaying entity to perform operations according to network operating requirements, the data service operating management that is desired by the carrier can be applied very easily and simply by way of the relaying entity without modifications or upgrades of various media decoding entities.

### DESCRIPTION OF DRAWINGS

FIGS. 1 and 2 illustrate examples of media index information and segment list information respectively that are provided for a client to select quality, etc. of a live media content and to request and obtain data of the selected quality in real time;

FIG. 3 illustrates, as seen from the programming point of view, the logical structure of related elements, which constitute a wireless terminal that an embodiment of a method for relaying data of a media content of which segment information is provided by way of list information is implemented in, and external entities connected to the wireless terminal according to the present invention;

FIG. 4 illustrates the structure of a wireless terminal according to one embodiment of the present invention in which a method for relaying data of a media content of which segment information is provided by way of list information is implemented;

FIG. 5 illustrates the structure of a play agent, together with a part of related elements in a wireless terminal, to relay data of a media content of which segment information is provided by way of list information according to one embodiment of the present invention;

FIG. 6 shows an example that the received media index information, which information about several components pertaining to a media content is included in, is delivered to another execution entity after being modified to media index information for a single component according to one embodiment of the present invention;

FIGS. 7 and 8 illustrate examples that modify remote source information for each segment to local source information therefor in segment list information received from a remote site according to individual embodiments of the present invention;

FIGS. 9 and 10 illustrate individual processes in which a content segment listed in list information, which is delivered to another execution entity, is requested on the basis of the list information and then delivered to said another execution entity in accordance with the individual embodiments illustrated in FIGS. 7 and 8;

FIGS. 11 and 12 show examples for better understanding of the process to relay a live media content as changing its quality according to an embodiment of the present invention;

FIG. 13 illustrates the structure of a play agent that relays data of a media content, whose segment information is provided by way of list information, according to one embodiment of the present invention;

FIG. 14 shows a figure to explain the process for relaying data of a media content being received to another execution entity continuously without data interruption even when a wireless network being used is switched according to one embodiment of the present invention;

FIG. 15 shows a figure to explain the process for relaying data of a media content, which is received through a plurality of networks, in sequence to another execution entity when usage of network is changed from single to joint-use, according to one embodiment of the present invention;

FIG. 16 schematically shows the process for preparing segment list information by omitting information about an arbitrary content segment from segment list information received from a remote site, and delivering the prepared segment list information to another execution entity, according to one embodiment of the present invention;

FIG. 17 schematically shows the process for preparing segment list information by replacing information about an arbitrary content segment from segment list information received from a remote site or inserting information about an additional media content therein, and delivering the prepared segment list information to another execution entity, according to one embodiment of the present invention;

FIG. 18 shows an example of section list information drawn up for a media content of which all data corresponding to total playtime have been already prepared, and a schematic process to prepare section list information by using partial information of the received section list information and to deliver the prepared section list information to another execution entity in sequence, according to another embodiment of the present invention; and

FIG. 19 shows a figure to explain the process for providing each piece of section list information in order as a response to request from a client in the event that each piece of section list information is drawn up for a part of sections divided from a media content in the embodiment of FIG. 18.

### MODE FOR INVENTION

In what follows, various embodiments according to the present invention will be described in detail with reference to the appended drawings.

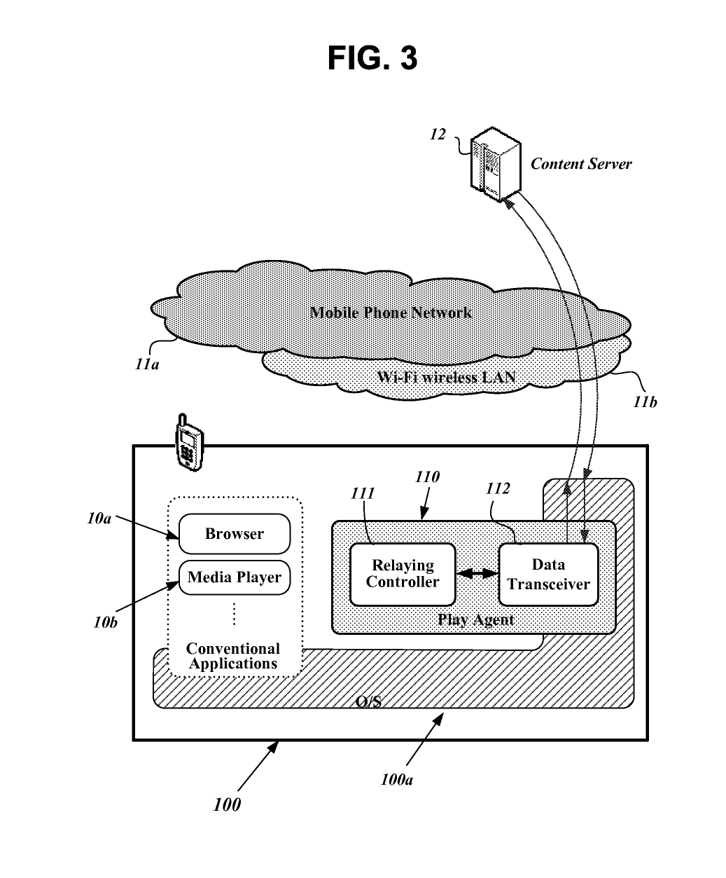

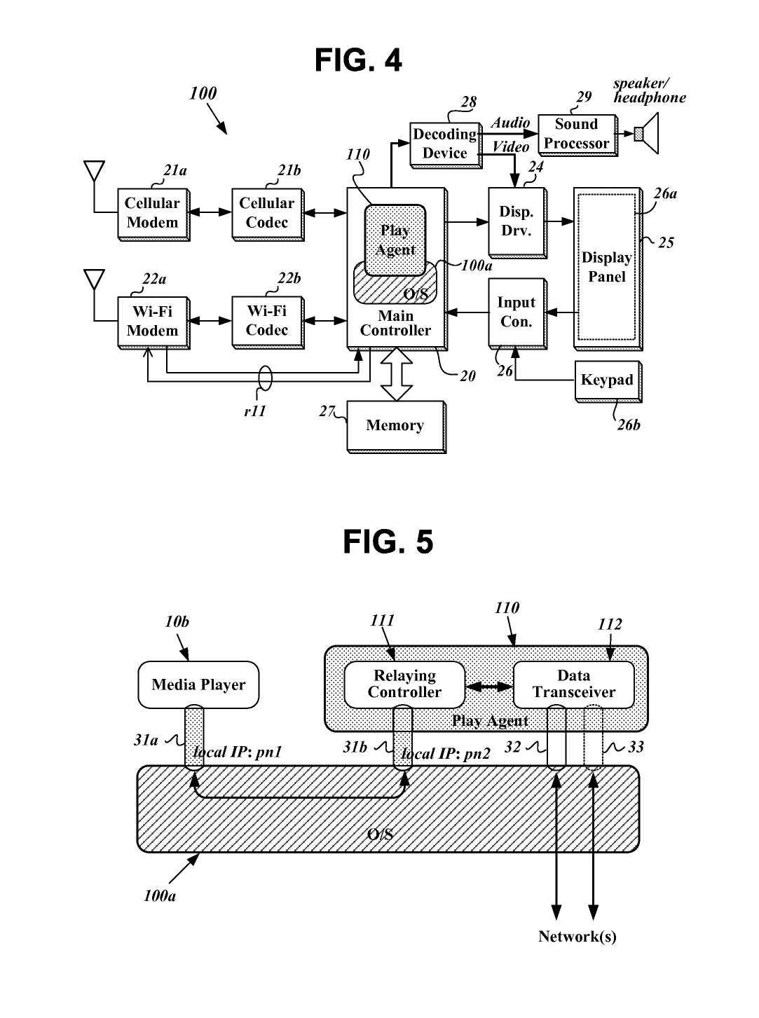

FIG. 3 illustrates, as seen from the programming point of view, the logical structure of related elements, which constitute a wireless terminal that an embodiment of a method for relaying data of a media content of which segment information is provided by way of list information is implemented in, and external entities connected to the wireless terminal according to the present invention. The logical structure of the wireless terminal 100 illustrated in the figure from the programming point of view comprises a conventional operating system such as Android, iOS, and Windows Phone or an operating system 100a specific to the present invention that is intended for driving hardware resources (illustrated in FIG. 4) of the wireless terminal 100 and exchanging appropriate signals and/or information with the corresponding resources. The logical structure may selectively comprise the conventional execution entities such as a browser 10a and a media player 10b that are executed based on the operating system 100a. Besides the media player 110, various other applications (hereinafter, application may be called ‘app’ for short) can be implemented based on the operating system 100a; however, since they are not necessary to describe the technical principles, spirit and scope of the present invention, other conventional applications have not been depicted in the figures. The illustrated wireless terminal 100 also comprises a play agent 110 which a method of relaying data of a media content, whose segment information is provided by way of list information, according to one embodiment of the present invention is embedded in.

The play agent 110 is a process or an app implemented or installed in the wireless terminal 100 and it can be provided in the form of software having a program structure consisting of command codes to be executed based on the operating system 100a as shown in FIG. 3. In case the play agent 110 is provided in the form of software, the media player 110 stored in a high-capacity storage means of a particular server may be downloaded into the wireless terminal 100 through a conventional on-line purchasing process from the particular server connected to a communication network, and can be then executed in the terminal 100 at any required time. Depending on situations, elements to perform at least a part of functions of the play agent 110, which are described in detail below, may have been embedded in the wireless terminal 100 in the form of middleware, a platform which apps run based on, or a part of the operating system 100a. Also, if a hardware component is incorporated into the play agent 110, it can perform a part of the functions of the play agent 110 that are described in detail below. Therefore, the scope of the present invention should not be limited by what type of resources or configuration is used to implement the play agent 110, the structure and operations of which are described in detail through various embodiments according to the present invention.

In one embodiment according to the present invention, the play agent 110 comprises, as individual sub-processes, a data transceiver 112 for creating a communication socket by selectively calling an API (Application Program Interface) provided by the operating system 100a and communicating data with an external entity through the created socket; and a relaying controller 111 for analyzing a received response compliant with communication protocol and requesting a media content on the basis of the received response. The relaying controller 111 delivers data of a media content, which is received through the data transceiver 112 according to a content request, to another execution entity, for example, the media player 10b and also delivers a received response to the media player 10b, if necessary after modifying information contained in the received response. In addition, besides the functions to be conducted by the above elements 111 and 112, the play agent 110 may conduct another a UI processing function to prepare a screen for interfacing a user by selectively calling API provided by the operating system 100a. In case the play agent 110 equips with the UI processing function, information required for or resulted from UI processing is exchanged with either of the sub-processes 111 and 112 that is related to the information. The data transceiver 112 ascertains which network can be accessed at present among a plurality of heterogeneous networks 11a, 11b through the operating system 110a according to a command from the relaying controller 111, and communicates data with an external server 12 (e.g., a content server 12 depicted in the figure) over a necessary or proper wireless network at present by using an access IP address allocated from the ascertained accessible network or by requesting allocation of an access IP address from another network indicated by the command.

In one embodiment according to the present invention, the play agent 110 comprising the data transceiver 112 and the relaying controller 111 can be implemented as a single process to be run based on the operating system 100a. In this case, exchange of information or data among them can be carried out by using global variables, local variables, or arguments and/or return values of local functions. Therefore, the concept, subject matter, and aimed effects of the present invention do not necessarily presume or require that the data transceiver 112 and the relaying controller 111 have to be separated from each other and implemented as separated individual processes, but they can be also practiced or achieved even when all the functions described below are integrated into the play agent 110 implemented in the form of a single process.

The wireless terminal 100 structured logically illustrated in FIG. 3 generally comprises such hardware components as shown in FIG. 4 and it may be any one of a smart phone, tablet computer, and a notebook computer equipped with resource for a wireless communication function that are capable of accessing a wireless network, for example, a public mobile network and/or a high-speed wireless data network, etc. To provide specific descriptions of the block diagram in the figure, the wireless terminal 100 comprises a cellular modem 21a (which includes a module for processing RF signals) for communicating with a public mobile network of cellular system 11a (e.g., 2G, 3G or 4G-typed mobile network), which is called ‘cellular network’ hereinafter, by modulating or demodulating a signal in compliance with the signaling system specified by the cellular network; a cellular codec 21b for encoding data or decoding encoded data in compliance with communication protocol adopted for the cellular network; a Wi-Fi modem 22a (which includes a module for processing RF signals) for communicating with a high-speed wireless data network, for example, a wireless LAN of Wi-Fi system 11b (called ‘Wi-Fi network’ hereinafter) by modulating or demodulating signals in compliance with the signaling system specified by the Wi-Fi network; a Wi-Fi codec 22b for encoding data or decoding encoded data in compliance with communication protocol adopted for the Wi-Fi network; a display panel 25 for visual display of an image, characters, and so on; a display driving unit 24 for driving the display panel 25 for arbitrary data to be displayed visually onto the display panel 25; a decoder 28 for decoding input encoded image and audio data and outputting the decoded image and audio data as visual and audible signals; a sound processor 29 for amplifying the decoded audio signals appropriately and outputting them through speaker/headphone, etc.; a touch sensor 26a attached at the front of the display panel 25; a keypad 26b equipped with keys and/or buttons; an input control unit 26 for sensing a user input and/or selection applied to the touch sensor 26a and keypad 26b, and outputting input information in accordance with the sensed result; a main controller 20 for communicating data with the above-mentioned elements or controlling them to carry out operation according to the input information outputted from the input control unit 26 or controlling the display driving unit 24 to provide a user interface (UI) intended for receiving the user's selection; and a memory 27 providing data storage space required for operations of the main controller 20.

The main controller 20 enables the operating system 100a to perform its own intended functions, which include driving hardware resources of the wireless terminal 100 and appropriate signal and/or information exchanges with a relevant resource, by executing pre-stored command codes such as an equipped firmware, etc., and also by executing command codes corresponding to all or a part of the play agent 110, it enables the play agent 110 to carry out operations that are described in detail hereinafter. The play agent 110 and other execution entities (apps or processes, etc.) request desired operations to the elements shown in FIG. 4 and perform data exchanges by invoking proper API that is provided by the operating system 100a. In particular, an execution entity for playing a media content, for example, the media player 10b can apply, if needed, the decoding operation performed in hardware by the decoder 28 to encoded image or audio data blocks through calling a relevant API provided by the operating system 100a.

The structure of the wireless terminal 100 illustrated in FIG. 4 is only an example intended to describe embodiments of the present invention in a specific and illustrative manner to help understanding of the concept and subject matter of the present invention. The wireless terminals implementing the concept and subject matter of the present invention can further include elements to provide various functions not shown in FIG. 4 or exclude one or more of the illustrated elements and moreover, a hardware element can be implemented by software and vice versa.

In what follows, described will be a process of relaying data of a media content, information on segments or sections of which is provided by way of list information, that is carried out in the wireless terminal 100, the logical structure of which is illustrated around the play agent 110 in FIG. 3.

First, a user activates the proxy function prepared in communication configuration through a proper user interface, which is provided through the I/O units (the display panel 25, the touch sensor 26a, the keypad 26, etc.) by the wireless terminal 100 or a browser 10a, and assigns the special address such as “127.0.0.1” or “localhost”, which is recognizable as an internal IP address by the operating system 100a, to the proxy together with a port number as IP address thereof. The port number assigned to the proxy should be identical to one assigned to the play agent 110 (or the relaying controller 111). The information assigned to the proxy is set to the operating system 100a or the browser 10a. As a result, the activated proxy function gets a complete IP address such as “127.0.0.1:8080” or “localhost:8080”.

In one embodiment according to the present invention, the above described proxy setting process may be automatically performed by the play agent 110 when the play agent 110 is installed in the wireless terminal 100 or is executed after installation. When or while the play agent 110 is run, it may detect whether the special local address and port number given previously as example have not been set for proxy function or when they are changed to other numeral information or the proxy function is deactivated, and notify a user of the detected situation through displaying suitable information such as a text to mean that stable and intellectual playing for a media content through co-using a plurality of heterogeneous networks is not guaranteed.

In other embodiments according to the present invention, a request compliant with communication protocol, for example an HTTP Request transmitted by an arbitrary app in the wireless terminal 100 may be intercepted at an external location to be redirected to the play agent 110 to which an internal IP address is allocated. Alternatively, the method that an arbitrary app inserts the local address (including a port number), which is allocated to the play agent 110, into the host field of a request compliant with communication protocol to be transmitted outwardly may be applied.

After any one of the above-explained methods including proxy function setting is applied, any request compliant with communication protocol, for example, an HTTP Request to be transmitted outwardly by an execution entity of the wireless terminal 100 is forwarded to the play agent 110. Then, the play agent 110 leaves processing of the request to the relaying controller 111. On the premise that any internally-generated request is processed like that, the operation of relaying data of a media content, the information on sections of which is provided by way of list information, within the wireless terminal 100 will be explained in detail hereinbelow.

First, a user executes the media player 10b prepared in the wireless terminal 100 through an appropriate user interface (UI) provided by the main controller 20, where the user interface is implemented through an I/O unit (the display panel 25, the touch sensor 26a, the keypad 26b, and so on) embedded in the wireless terminal 100. Once the media player 10b is run, a URL for a live media content, for example, “http://live.airplug.com/2012-8-24_baseball_AvsB.m3u8” is entered directly through an input window on player screen built on the display panel 25 by the media player 10b, or is selected from a suggested live content list. A request compliant with communication request for such directly-entered or selected URL is forwarded to the play agent 110 according to the aforementioned premise. The forwarded request to the play agent 110 is processed by the relaying controller 111. Alternatively, the request is directly forwarded to the relaying controller 111 from the media player 10b. The forwarding of a request compliant with communication protocol to the play agent 110 (or the relaying controller 111) can be achieved through a pair of local sockets 31a and 31b (sockets for information exchange between internal entities in compliance with IP-based communication protocol) created by the operating system 100a as illustrated in FIG. 5.

As delivering the received request compliant with communication protocol to the data transceiver 112, the relaying controller 111 commands the data transceiver 112 to transmit the request. Then, the data transceiver 112 calls on the operating system 100a for creating a socket to use for data communication with an external server. The operating system 100a ascertains the information carried by the request complaint with communication protocol, the access IP address of the currently connected wireless network (or allocated newly from a designated wireless network) and the port number assigned to the data transceiver 112 (or the play agent 110 in some cases) which called for socket creation, and then it establishes with a destination server of the request compliant with communication protocol, for example, the content server 12 a TCP connection that is identified by the ascertained information. Once the TCP connection is established successfully, the operating system 100a creates a socket 32 in connection with the TCP connection and returns the identifier of the created socket 32 to the data transceiver 112 in response to the request for creating a socket. When the identifier of the created socket 32 is returned, the data transceiver 112 commands the operating system 100a, through the socket 32 indicated by the identifier, to transmit the previously delivered request compliant with communication protocol, for example, the HTTP Request for a URL of “http://live. airplug.com/2012-8-24_baseball_AvsB. m3u8”.

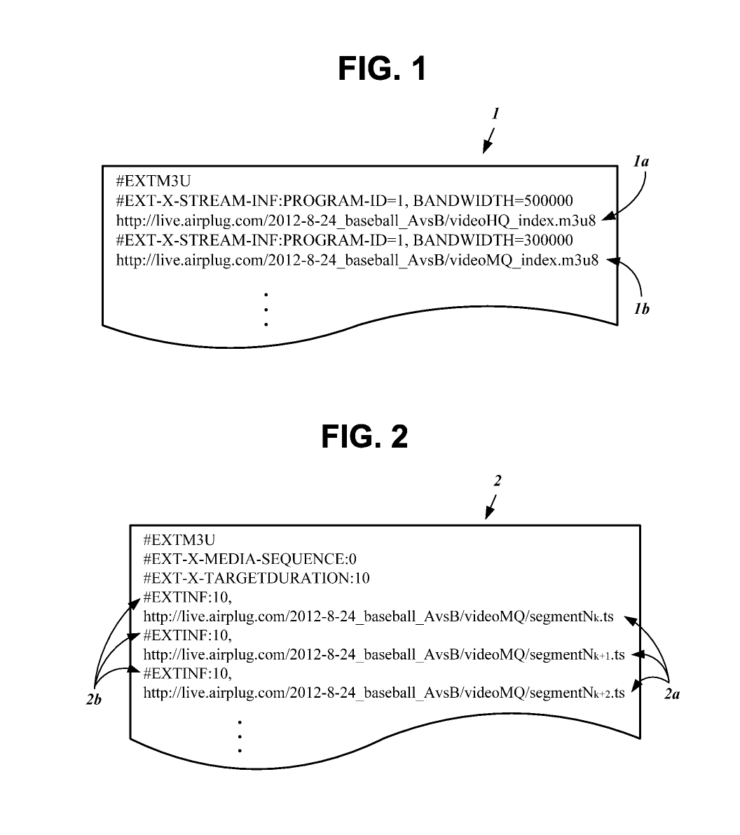

The operating system 100a then transmits the received request compliant with communication protocol through hardware resources (the cellular codec 21b/the cellular modem 21a in case of the cellular network 11a being connected, or the Wi-Fi codec 22b/the Wi-Fi modem 22a in case of the Wi-Fi network 11b being connected) for the wireless network, associated with the socket 32, that is connected for current data service (namely, the network from which an access IP address has been allocated). When receiving the HTTP Request sent by the data transceiver 112 to demand a live media content, the content server 12 provides, as a response to the HTTP Request, media index information including a list of providable stream components as illustrated in FIG. 1. When the data transceiver 112 receives the provided response through the previously created socket 32 from the operating system 100a, it delivers to the relaying controller 111.

After storing the received media index information for its later use, the relaying controller 111 selects a media component of a default quality, for example, the required bandwidth of which is within the range of 250000˜350000, edits the media index information so that information about other components except the selected component 401 may be removed from the media index information, and delivers the edited media index information 40 to the media player 110b that requested a live media content initially. At this time, the relaying controller 111 may add an address, which identifies the play agent 110 (or the relaying controller 111 itself) based on IP address system, into information about the selected component as host field information. As a matter of course, the delivering of the media index information 40 is accomplished through the pair of sockets 31a and 31b that were created for data communication with the media player 10b. In another embodiment according to the present invention, the default quality may be the highest one 402 in the received media index information. Furthermore, a single component may be chosen from the media index information according to various conditions and then delivered to the media player 10b as media index information about only single component. Several examples of those various conditions will be described later.

In one embodiment according to the present invention, the modifying of the received media index information to contain information about only single component and the delivering of the modified media index information to another execution entity may be optionally conducted by the relaying controller 111 according to configuration set to the play agent 110 by a user depending on his/her preference. For instance, if a field named “intelligent component selection” is set activated in the configuration, the relaying controller 111 conducts the above-explained component selection and editing of media index information to be suitable to the selection. If set inactivated, the relaying controller 111 delivers the media index information to another execution entity as received without edition. In this case, a single component will be selected from the delivered media index information by said another execution entity.

The above explanation is about the process where a certain live media content is initially chosen by the media player 10b and media index information is delivered to the media player 10b as a response to its own request for the content. However, after a certain live media content is initially selected by another execution entity, a response to a request from said another execution entity may be finally delivered to the media player 10b. For instance, if a user selects an item linked to a certain live media content, which will be provided by an external sever (e.g., the content server 12 shown in the figure), through the browser 10a in order to view that live media content, a request compliant with communication protocol for URL (e.g., “http://live.airplug.com/2012-8-24_baseball_AvsB.m3u8”) associated with the chosen item is transmitted to the content server 12 by way of the play agent 110 and then a response including media index information arrives at the play agent 110. After editing the media index information as explained above, the play agent 110 delivers the edited response to the browser 10a. The response received by the browser 10a includes information such as description information about a file provided as a response, for example, MIME (Multipurpose Internet Mail Extensions) type and total size of the file, etc. Therefore, the browser 10a executes the media agent 110, i.e., an app associated with the MIME type written in the received response. The association with the media agent 110 can be also made by the file extension rather than the MIME type. Executing the media agent 110, the browser 10a delivers the URL (e.g., “http://live.airplug.com/2012-8-24_baseball_AvsB.m3u8”), which has caused the response, or a request compliant with communication protocol prepared according to the URL to the executed media agent 110 as a calling argument. Then, the media player 10b processes the calling argument in the same manner as a direct input for a live media content from a user. That is, a request is prepared for a live media content of which information is delivered by the calling argument and then delivered to the play agent 110. Finally, the media player 10b will receive a simplified media index information, which contains information about only single media component chosen by the play agent 110 as described above, from the play agent 110.

In one embodiment according to the present invention, in case an execution entity that selected a certain live media content initially is not identical to an execution entity that will receive media index information or list information for sections of the selected live media content, the execution entity having selected a live media content initially, for example, the browser 10a may notify the play agent 110 of source information (e.g., URL) on the selected live media content, and command another execution entity being capable of playing the live media content, for example, the media player 10b to receive media index information or list information for sections of the live media content from the play agent 110. In this case, when notifying the play agent 110 of information used for obtaining the selected media content from a remote site, the browser 10b also delivers media content targeting information that will be used by the media player 10b to request the media content. The browser 10b delivers the media content targeting information to the media player 10b too. All the media content targeting information delivered to the media player 10b may not be necessarily identical to the information delivered to the play agent 110. For instance, the media content targeting information delivered to the media player 10b includes a local address to indicate the play agent 110 but the media content targeting information delivered to the play agent 110 may not include a local address. In the present embodiment, after associating the media content targeting information sent from the browser 10b with source information about the selected media content, the play agent 110 starts to obtain media index information about the selected content using the source information. If the media content targeting information is received from the media player 10b during such obtaining process, the play agent 110 provides, in response to the received media content targeting information, the media player 10b with a response that is received according to request using the source information of a media content associated with the received targeting information. Naturally, the simplifying of the media index information so that it may contain a single media component may be conducted by the play agent 110 as described above in the response providing.

The media player 10b requests the single media component (or a component selected among from a plurality of media components) listed in the provided response to the play agent 110. Then, the request from the media player 10b is transmitted to the targeted server, for example, the content server 12 by the play agent 110 as explained above. Instead of transmitting the request as received, the relaying controller 111 may draw up a new request compliant with communication protocol with reference to the received request from the media player 10b and transmit the newly drawn-up request specifying that a related component is demanded by the relaying controller 111 (or the media agent 110). In response to the transmitted request, the content server 12 forwards list information in which the latest several sections (a section of a live media component is also called ‘segment’ in this specification) are listed from among content sections of which data is providable at this time with respect to the requested component. In general, when a live media content is provided, its data is created every a predetermined time. In this specification, such data block created for a predetermined time is called ‘segment’. The list information of segments transmitted from the content server 12 is received by the relaying controller 111 by way of the data transceiver 112. The relaying controller 111 starts to obtain each content segment sequentially from the remote sever, i.e., the content server 12 by requesting it through the data transceiver 112 with reference to the received segment list information (abbreviated to ‘SgLI’ hereinafter). For each of the received content segments, the relaying controller 111 allocates a file of temporary filename or a memory space and stores data of a corresponding segment into the allocated file or memory space. While such data storing is conducted, the relaying controller 111 excerpts all or some of the content segments from the received SgLI, draws up a new SgLI by modifying the remote source information to the local source information for each of the excerpted segments, and provides the drawn-up SgLI for the media player 10b as a response to the component request received before. The relaying controller 111 may conduct the operation, which draws up a new SgLI on the basis of the received SgLI and delivers to the media player 10b, before obtaining data of each content segment from the content server 12. In this case, after allocating a file or a memory space for each of content segments listed in the received SgLI, the relaying controller 111 determines the local source information from information about the allocated repository, and writes the determined local source information into the SgLI to be provided to the media player 10b.

After providing the SgLI to the media player 10b, the relaying controller 111 records in a last indicating variable (contracted to ‘LIV’ hereinafter) the information (e.g., the sequence number contained in the filename assigned to a related segment) identifying a content segment of which the source information is written lastly in the provided SgLI. The LIV is referred later in determining from which segment the SgLI to be provided is prepared to include among the content segments having been stored or being stored when the media player 10b requests update of SgLI.

In one embodiment according to the present invention, when providing the media player 10b with the SgLI modified such in manner that the remote source information of each content segment is replaced, the relaying controller 111 may provide information about only a part of segments excerpted from the received SgLI to the media player 10b as explained above. For instance, the relaying controller 111 may prepare an SgLI to include only content segments of which data are received completely while replacing the remote source information with the local one for each of the included segments, and provide the prepared SgLI. Alternatively, each time the media player 10b requests an SgLI, the relaying controller 111 may draw up an SgLI to include source information about only single content segment or content segments, each corresponding to a predetermined time length, e.g., 10 or 20 seconds, and provide it to the media player 10b. Of course, the previously-provided SgLI may be provided to the media player 10b again if there is no content segment received newly from the content server 12 when an SgLI is requested from the media player 10b.

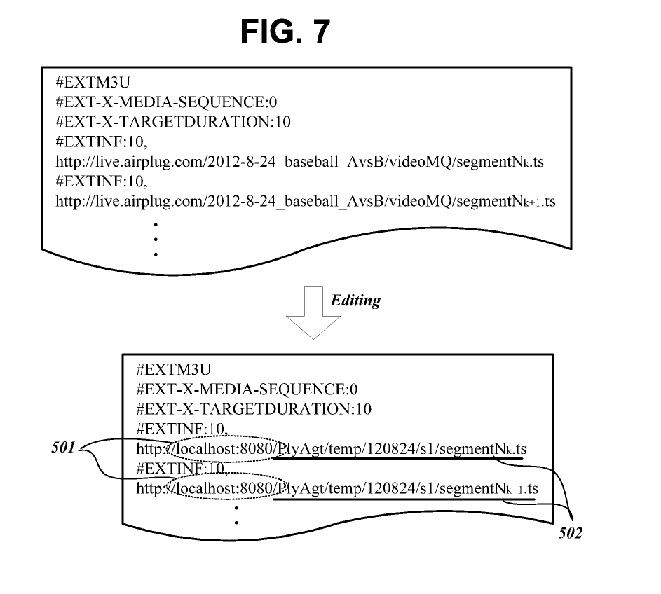

In one embodiment according to the present invention, the local source information to be inserted to replace the remote source information included in the received SgLI is IP address-based information 501 (localhost:port number) to indicate a local execution entity as illustrated in FIG. 7. What is indicated by the IP address-based information 501 is surely the play agent 110 (or the relaying controller 111). If there is another execution entity for delivering data of content segments that conducts the operation of providing stored data to an execution entity which requests based on IP-address system, the IP address-based information 501 to indicate said another execution entity may be used to replace the remote source information. In this case, said another execution entity reads data of received content segments and sends them as a response to the media player 10b each time the media player 10b requests content segments based on IP-address system the same as the relaying controller 111 does. The relaying controller 111 completes edition of the source information about each content segment by inserting, right after the IP address-based information 501 to indicate the local execution entity, the pathname 502 given to a repository, for example, a file allocated for each content segment having been or being received according to requests transmitted through the data transceiver 112. Each content segment of which data is stored in the memory 27 in form of a file can be identified and accessed by a file pathname by way of file system that is being run by the operating system 100a. In one embodiment according to the present invention, the file pathname given to a file may be different from actual pathname of the file storing data of a content segment. In this case, the pathname added to the local source information becomes a virtual pathname, and the relaying controller 111 associates a virtual pathname assigned by itself with an actual pathname of the same file. In another embodiment according to the present invention, the received data of each content segment may be stored in a repository, for example, a memory space identified by memory address, that is indicated differently from file-based indication. In this case, a virtual file pathname (including filename) compliant with the file system is given to the memory space or its memory address, and the virtual file pathname is added next to the information 501 indicating the local execution entity, so that edition of source information for each content segment is finished. The virtual file pathname is used to indicate an associated memory space and even if it indicates some file accidently on file system of the operating system 100a, it is irrelevant to that file. The relaying controller 111 associates the virtual file pathname given to a memory space with a memory address of that space.

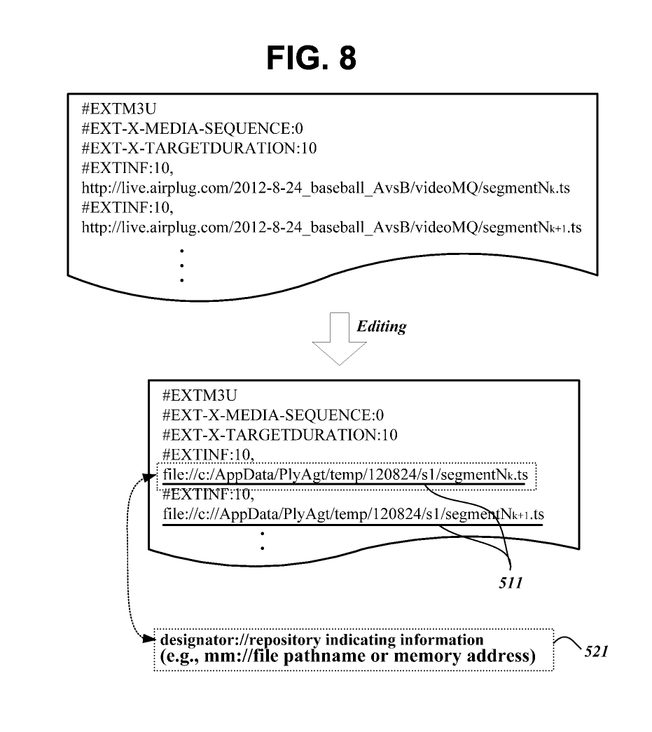

In another embodiment according to the present invention, as illustrated in FIG. 8, the remote source information relating to a file of each content segment may be replaced with access directing information 511 that uniquely specifies a corresponding content segment, whose received data is stored in the memory 27, in conformance with the local file system. Alternatively, the local source information for a content segment being stored in the memory 27 is specified and informed to another execution entity, i.e., the media player 10b in compliance with the pre-agreed manner and format. For instance, as illustrated in FIG. 8, the local source information 521 to be written to replace the remote source information for a content segment may be specified in such a manner that a designator interpretable by the media player 10b is positioned at the head part of protocol field and the information indicating a repository storing the corresponding content segment is added right following the designator. Needless to say, the repository may be a file or a memory space allocated in the memory 27 through a memory address.

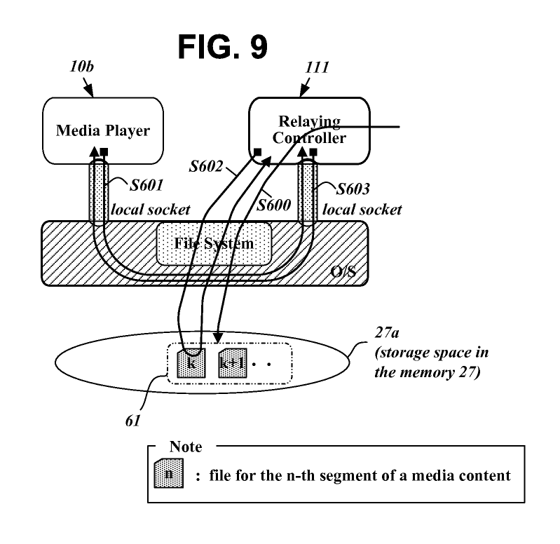

When receiving the SgLI, re-drawn up by the relaying controller 111, of which source information is modified as illustrated in FIG. 7, the media player 10b conducts requests for individual content segments based on the SgLI as illustrated in FIG. 9. Each request from the media player 10b is delivered to the relaying controller 111 via the operating system 100a, S601. In this request delivery by way of the operating system 100a, new sockets may be created to be used for mutual communication between the media player 10b and the relaying controller 111 or the existing pair of sockets 31a and 31b may be used. When receiving each of requests, the relaying controller 111 accesses a file which is identified, among files 61 received from a remote site and stored S600 in the local storage space 27a, by the file pathname 502 included in an address written in the request, and prepares a response compliant with communication protocol with data of the accessed file S602 to react to the received request for a content segment. With regard to the information 501 in the host field written in the request, a preset default directory (e.g., “c:\AppData\”) is instead used to specify a full file pathname. In another embodiment according to the present invention, if the request for a content segment from the media player 10b includes a virtual file pathname, the relaying controller 111 accesses a memory space or a file identified by information (for example, a memory address or an actual file pathname) stored in connection with the virtual file pathname, and prepares the response compliant with communication protocol with data of the accessed space or file to the request for a content segment. In preparing the response, the relaying controller 111 draws up a response to the received request when data of a content segment corresponding to the request is all written in a repository, in other words, when data of a content segment being written in a corresponding file or memory space is entirely received. After preparing the response, the relaying controller 111 sends it to the media player 10b through the local socket S603. Even if data of the corresponding content segment is not entirely received, the relaying controller 111 may draw up a response and forward it to the media player 10b. In this case, each time a received data is filled above a predetermined size in a corresponding file or memory space, the relaying controller 111 transmits the filled amount of data through the local socket as a part of the previously-forwarded response. In accordance with the above-explained relaying operation of the relaying controller 111, each content segment having been stored or being stored in the local storage space 27a is retrieved therefrom to be delivered to the media player 10b.

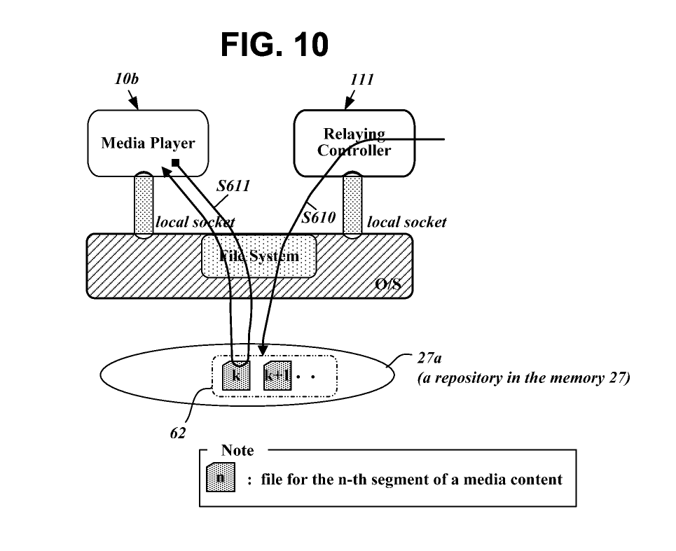

If the SgLI re-drawn up by the relaying controller 111, of which source information is modified as illustrated in FIG. 8, is received, the media player 10b identifies a file among files 62 of content segments, each having been stored or being stored S610 as illustrated in FIG. 10, through the file system of the operating system 100a by the associated file pathname 511, and then obtains data of the identified file directly S611. Alternatively, if the local source information for each content segment listed in the received SgLI contains the designator informing the pre-specified manner or format 521, the media player 10b may analyze the repository indicating information right following the designator according to the predetermined rule, and obtain data of a corresponding content segment from a repository, for example, a file or a memory space that is determined from the information analysis. In this embodiment, a request based on the SgLI of which source information is edited by the relaying controller 111 is not delivered to the relaying controller 111 unlike in the embodiment illustrated in FIG. 9. Naturally, the preparing and providing a response including data of a content segment is not conducted by the relaying controller 111 either.

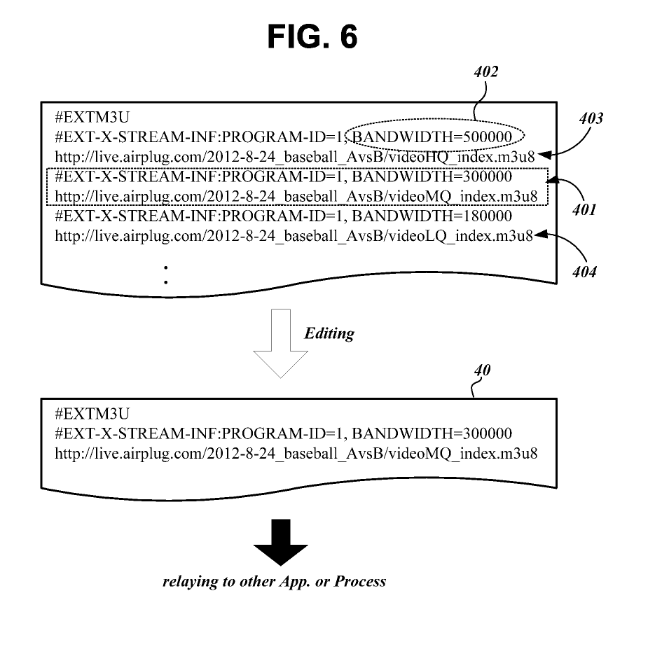

In the meantime, the relaying controller 111 also conducts an operating to request and receive an SgLI for other components excluding the component 401 chosen in default by itself (or chosen and demanded by another execution entity) from the received media index information illustrated in FIG. 6, in order to change quality or attribute (video or audio) of a concerned media content adaptively later according to communication state, etc. This will be described in more detail below.

In order to ascertain communication state for adaptive change between qualities or attributes of a concerned media content, the data transceiver 112 measures the speed to receive data at through a socket, namely, a bandwidth of receiving channel when receiving data through the socket from the operating system 100a to provide it to the relaying controller 111. As one method for measuring the receiving bandwidth, after transmitting a request compliant with communication protocol, which is received from the relaying controller 111, for each content segment through a socket, the data transceiver 112 measures' the receiving bandwidth based on the amount of data received in response to the transmitted request for an interval from when of receiving the responding data firstly to when of receiving the last responding data. As another method, the receiving bandwidth can be calculated from a time being taken to receive data of a predetermined size, e.g., a few hundreds KBytes through a socket. It may be, to be sure, averaged from individual receiving speeds measured for the latest data receiving intervals or averaged in weighted manner therefrom.

Furthermore, the relaying controller 111 keeps ascertaining the speed required of decoding (abbreviated to “demanding speed” hereinafter) a concerned media content (i.e., a current component) that is being received at present in order to determine whether the aforementioned adaptive change is to be made for the media content. For the continuous ascertaining, each time data of a single content segment is entirely received, the relaying controller 111 finds the demanding speed of the concerned media content from a speed value (=segPlyT/segDataS) that is obtained by dividing the playback duration ‘segPlyT’ (this can be known from the SgLI) of the single content segment by the size ‘segDataS’ thereof. For instance, whenever a single content segment is completely received, the relaying controller 111 may regard a speed value for the completely-received segment or an average of speed values found for lately-received several segments as the demanding speed. Alternatively, the demanding speed of a currently-received component may be ascertained from the fixed value of bandwidth (e.g., 402 in FIG. 6) that is specified for each component in the previously-received media index information.

While relaying every content segment being received to the media player 10b as explained above, the relaying controller 111 ascertains the receiving bandwidth measured by the data transceiver 112 and compares it with the demanding speed of a current media content. If the result of the comparison tells that the receiving bandwidth is enough for or does not afford the demanding speed, the relaying controller 111 conducts an operation to change from a currently received component to another component to receive from now on. That is, the relaying controller 111 automatically controls the bit rate of the concerned media content being received. For instance, if the ratio of the current receiving bandwidth to the demanding speed (more particularly, an average of the ratios for a predetermined time) is equal to or greater than 2, the relaying controller 111 increases the bit rate of the media content by changing to another component, which requires higher demanding speed than the current component, to be received for the concerned media content. Whether the ascertained receiving bandwidth can support the demanding speed of said another component may be checked before the component change. If the ratio is equal to or smaller than 1.1 or 1.2, the relaying controller 111 decreases the bit rate of the media content by changing to another component, which requires lower demanding speed than the current component, to be received for the concerned media content. On the premise of the example shown in FIG. 6, the component to receive from now on is changed to the component 403 indicated by “. . . /videoHQ_index.m3u8” in the former case, and to the component 404 indicated by “. . . /videoLQ_index.m3u8” in the latter case.

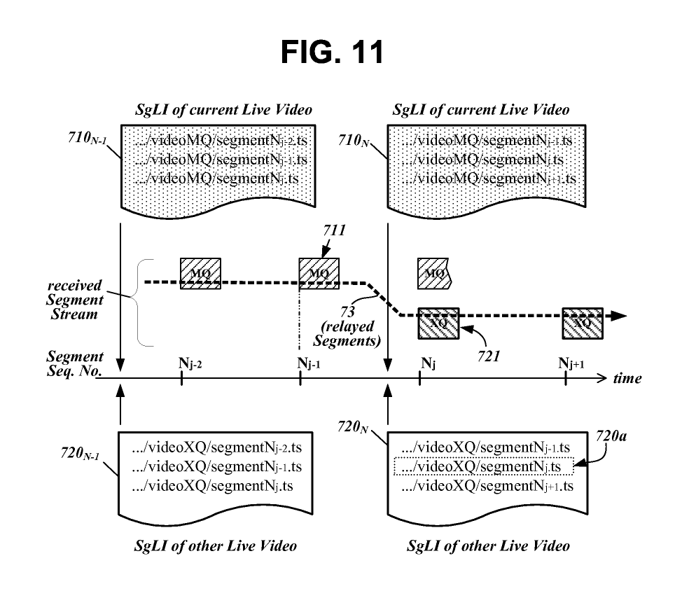

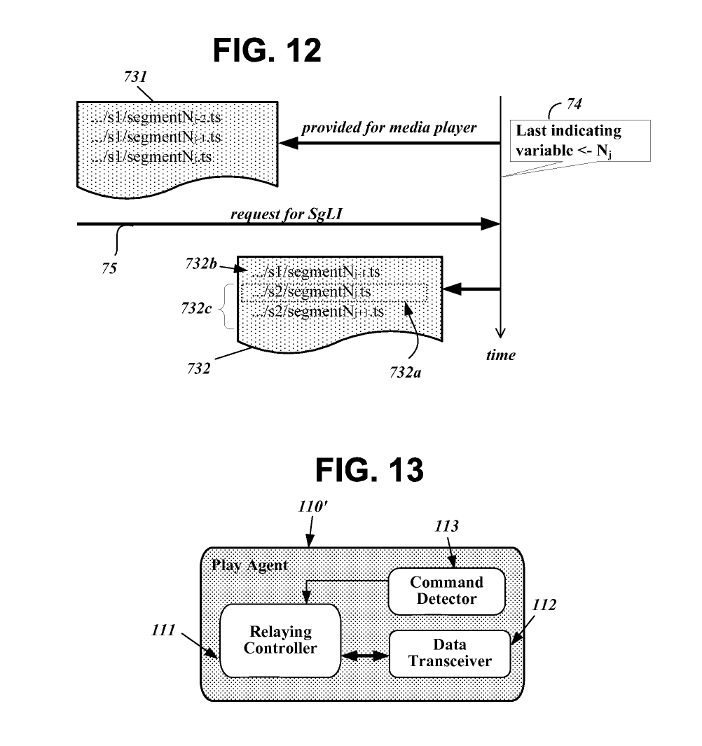

FIGS. 11 and 12 are figures for better understanding of the component changing process (the bit rate change for the media content). The method conducted by the relaying controller 111 for relaying data to the media player 10b as changing a media component being currently received will be explained in detail with reference to FIGS. 11 and 12.

Determining a target component that starts to be received after component change, the relaying controller 111 searches the SgLI 720ᵢ (i=. . . , N−1,N) having been received for the target component, preferably the last received SgLI 720_{N} for the filename that has sequence identifying information (which may be, for example, the number included in the filename of a content segment to indicate the order Nⱼ on a series of segments and is called ‘sequence ID’ hereinafter) following an sequence ID Nⱼ₋₁ of the last content segment 711 of which data is entirely received with respect to the currently received component. If it is found, the relaying controller 111 draws up a request compliant with communication protocol on the basis of the source information 720a of the found filename including the sequence ID Nⱼ and commands the data transceiver 112 to transmit the drawn-up request. The data transceiver 112 stores a new content segment 721, which is received for the changed component according to the transmitted request, in a place (i.e., directory or folder) that may be not where a previous component before the component change is stored. For instance, as illustrated in FIG. 7 or 8, a directory or a folder where the previous component before the change was being stored is “. . . /s1/” in the local storage space 27a while the changed component is stored in another directory or folder such as “. . . /s2/”. For the content segments to follow the segment from which component change is made, the relaying controller 111 requests them sequentially on the basis of the SgLI 720_{N} related with the changed component. Even after the component change, the relaying controller 111 updates SgLI for every component listed in the previously-obtained media index information periodically or when information about additional content segments is needed.

After changing component to be received and stored as described before, if a request for an SgLI (this is for an SgLI, for example, “. . . /videoMQindex.m3u8” in FIG. 6 related to the initially-chosen component) is received from the media player 10b, the relaying controller 111 prepares an SgLI for content segments, of which each remote source information is replaced with local source information, that have been or is being received next to the content segment whose order, e.g., sequence ID is indicated by a value of the LIV, and then provides it to the media player 10b in response to the request for SgLI. The relaying controller 111 may insert into the prepared SgLI the local source information for past segment(s) whose order is equivalent to or precedes a value of the LIV. As a result, information may be provided repetitively for a part of content segments. In particular, if the LIV indicates the sequence ID Nⱼ, which component change takes effect from, or the subsequent sequence ID when component change is made as described above, an SgLI is drawn up in such a manner that it is duplicated with the previously-provided SgLI in some content segments in order that source information for the content segment segment Nⱼ of the changed component may be included therein. As illustrated in FIG. 12, if it is assumed that the SgLI 731 provided previously to the media player 10b is about the content segments Nⱼ₋₂, Nⱼ₋₁, and Nⱼ {the LIV is probably indicating, for example, Nⱼ (or a file corresponding to that order) 74}, the SgLI 732 to be provided to the media player 10b is prepared by the relaying controller 111 in response to the request for updating SgLI 75 so that it may include again at least the segment 721 of sequence ID at which component change is made. According to such preparation of SgLI at component change, the SgLI to be provided to the media player 10b may temporarily include information 732b about the content segment pertaining to the previous component before change as well as information 732c about the content segments pertaining to the current component after change as illustrated in FIG. 12. Of course, after the transit time of component changing elapses, the SgLI to be provided to the media player 10b is drawn up by the relaying controller 111 to list only content segments, each source information of which is modified to local source information, of the changed component.

Even in the event that the component change is made by the relaying controller 111 as described above, the media player 10b keeps, irrespective of such component change, requesting update of SgLI for the component demanded initially by itself and obtaining content segments sequentially based on the SgLI being updated continually. In other words, even though the media player 10b conducts no operation to change bit rate of the media content being played, the quality of the media content being received is changed adaptively by the play agent 110 while the media player 10b is playing the content.

The adaptive quality change for a media content explained above may be conducted based on not only communication state but also other predetermined conditions, etc. For instance, the adaptive quality change can be conducted based on an item named “automatic quality-change condition” that is set in the configuration of the play agent 110 by a user through UI prepared by the play agent 110. If “the highest quality in case of a specific network (e.g., Wi-Fi network)” is set for the item of “automatic quality-change condition”, while receiving an initially selected component of quality set to default (or quality requested by another execution entity) with respect to a chosen media content, as explained above, the relaying controller 111 checks the type of a currently-connected or -used network or a changed network for use, and changes quality of a current media content to the highest as described above in case the checked type is Wi-Fi and the component being received at present is not highest in quality as well. If “quality degrading in case of a specific network (e.g., cellular network)” is set for the item of “automatic quality-change condition”, the relaying controller 111 changes to lower quality component than a current component being received when network usage of the wireless terminal 100 is switched to the cellular network 11a. The type of network being used can be known from network connection information that is returned from the operating system 100a in response to query thereto. The network connection information includes an access IP address, connection type (for example, 3G or 4G mobile network, Wi-Fi network, etc.) and so on under the condition that the wireless terminal 100 is connected to a wireless network or networks. The above-explained adaptive quality changing method is also conducted when a component of previous quality starts to be received again on the ground that connection of the wireless terminal 100 to a wireless network is released and is then made to another network, for example, the cellular network 11a. The connection to a wireless network or release thereof can be informed from an event generated by the operating system 100a.

The above-explained adaptive quality change depending on the type of network to be used is preferable because the cost to be charged to a user who uses wireless data service is generally different for each type of wireless networks. For instance, the cost could be charged depending on the amount of used data when the cellular network 11b is used for data service, however data service by way of the Wi-Fi network 11b is available at no cost to users. Therefore, the above-explained adaptive quality changing has a different meaning that quality change is to be made when network change causes a difference in cost for usage of data service. That is, the above-explained adaptive quality changing method can be conducted in the event that the item of “automatic quality-change condition” specifies an instance of “connection switching between networks of mutually different service charges”. In this situation, special information on which type of network is more advantageous to a user from the standpoint of cost on the premise of the same amount of data usage is pre-stored in the relaying controller 111.

As another example, if the item of “automatic quality-change condition” is set to “excess over a reference amount of data usage”, the relaying controller 111 continues to compare a reference also set in the item of “automatic quality-change condition” with the amount of data being used with respect to a predetermined specific network, for example, the cellular network 11a for a term (e.g., one month) specified by a rate schedule for data service. If the amount of data being used exceeds the reference, the relaying controller 111 changes quality of a media content to the lowest one in the event that the specific network is being used and the quality of current component is not lowest. The information on the amount of data usage by the wireless terminal 100 can be obtained from a specific server by querying current data usage state for the terminal 100 thereto as providing a unique identification (e.g., subscriber telephone number) of the terminal 100 that is obtained from the operating system 100a by calling a proper API. In response to the query, the specific server provides information about how much data is used within a term specified by a rate schedule by the querying terminal with respect to the specific network or individual wireless networks. Alternatively, the relaying controller 111 calculates the amount of data usage for a term specified by a rate schedule with respect to each type of wireless networks by referring to total amount of data usage being accumulatively counted for usable wireless networks respectively by the operating system 100a. Therefore, if a user sets the reference amount, which functions to suppress the amount of data usage, to 50% or 70% of the maximum amount of data usage that can be used without no additional cost, a current media content is downgraded to lower quality by the adaptive quality change algorithm as explained above when the amount of data usage with respect to the cellular network 11a exceeds the reference. As a result, the amount of data usage for which a user is responsible is reduced as much as possible.

A service managing policy of a carrier to operate wireless networks may correspond to the aforementioned predetermined conditions that are applicable to the adaptive quality change for a media content. For example, in the event that a carrier to operate a certain type of wireless network, particularly the cellular network 11a forces the amount of data usage on a certain service cell to be limited, the adaptive quality changing method can be also performed based on information given for the limitation. To be specific, in the event that load control information for limiting the amount of data usage is received, the relaying controller 111 ascertains a limit (e.g., a limit speed for data reception) indicated by the received load control information and changes to another component to require a lower bandwidth than the ascertained limit if the demanding speed of a current component being received through the cellular network 11a exceeds the limit. The process and structure of the relaying controller 111 for receiving the load control information will be described later.

The selection of a particular quality for a component, which is explained in detail about examples of the predetermined conditions, etc. for the above-described adaptive quality change, is applicable to even when the relaying controller 111 selects a single component initially from the received media index information illustrated in FIG. 6. For example, if the currently connected (or used) wireless network is the Wi-Fi network 11b, a component of the highest quality is selected from the media index information, and if the cellular network 11a is currently used and the amount of data usage with respect to that network is above a preset reference, another component of the lowest quality is selected. In addition, if the limit is set at present after the aforementioned load control information is received, a proper component of the demanding speed lower than the limit is selected. After a single component is selected in that way, the relaying controller 111 draws up media index information for only the selected component and then provides it to the media player 10b.

In compliance with the method explained with several examples above, the relaying controller 111 switches appropriately among components depending on communication state, or preset conditions, etc. and provides the media player 10b with an SgLI including source information indicating a local repository from which the switched component can be accessed. And, the media player 10b requests the play agent 110 to deliver data of that component based on the SgLI or accesses directly a corresponding file through file system of the operating system 100a. As a result, even though the media player 10b just repeats to obtain data of the initially-selected media content without conducting any special operation, data pertaining to the media content of which quality or attribute is different from one being currently played can be received 73 and then played.

In one embodiment according to the present invention, the relaying controller 111 may switch a wireless network being used or use a plurality of wireless networks altogether according to current communication state while data of a media content is received. For instance, in the event that the quality of a media content being received is to be lowered, the relaying controller 111 changes to another available network other than a currently used network or uses said another available network together with the currently used network before or after lowering the quality. In addition, if another network (e.g., the Wi-Fi network 11b) other than the currently used network is found available while searching for any available wireless network periodically, the relaying controller 111 may raise the quality of a media content being received by using the found network additionally or change to the found network for using data service. Whether or not the Wi-Fi network 11b is available can be known from information about Wi-Fi network which is provided by the operating system 100a at the request. In response to the request for the information, the operating system 100a controls the Wi-Fi modem 22a to physically search the radio bandwidth allocated for Wi-Fi. Afterwards, it returns to the relaying controller 111 an identification and an RSSI (Received Signal Strength Indicator), etc. of each found AP (Access Point) that are provided by the Wi-Fi modem 22a (r21 in FIG. 4) when an effective signal is detected in the Wi-Fi bandwidth. If the returned information includes an arbitrary AP (specially, an AP whose SSID has ever been connected), the relaying controller 111 determines that the Wi-Fi network is available now. In the meantime, even in the case that connection to a currently used network, for example, the Wi-Fi network 11b is released, the relaying controller 111 automatically forces the wireless terminal 100 to connect to another available network, for example, the cellular network 11a so that data of a media content may be continuously received.

In addition, the connection of the wireless terminal 100 may be switched from a currently used network, for example, the cellular network 11a to another wireless network according to a command signal transmitted in the situation specified by a carrier to operate wireless networks. For this embodiment, a play agent 110′ may be structured to further include a command detector 113 as illustrated in FIG. 13. The command detector 113 periodically checks whether a special wireless signal of the cellular network 11a, for example, control signals transceived through the paging channel is detected or not by calling a proper API for communication information related with the cellular network that is provided by the operating system 100a. A load control server, which functions to adjust loads to be burdened to a wireless network, especially the cellular network 11a providing mobile communication service, determines whether data traffic on any service cell is needed to be restricted forcibly and urgently based on reports informing traffic served by each base station covering a service cell. If the reports tell that traffic on a certain service cell is increased highly in a moment, the load control server transmits urgent load control information, which is targeted at a base station covering that service cell, to an exchanger for the targeted base station through a private network in order to forcibly restrict traffic burdened on that cell. Receiving the urgent load control information via an exchanger, the targeted base station transmits the received control information wirelessly after inserting the received control information into a proper position of wireless signal format. Then, the mobile stations including the wireless terminal 100 detect the urgent load control information through their cellular codec. After being decoded by the cellular codec 21b, the urgent load control information is delivered to the operating system 100a. Instead of periodic checking, the command detector 113 may request the operating system 100a to register a task which is to inform of a fact that a specific urgent load control information is received. After the task is registered in the operating system 100a according to the request, the command detector 113 is notified of the fact by an event that is generated by the operating system 100a the moment the desired information is received at the wireless terminal 100.

In case wireless signals of the cellular network 11a carry the load control information, the command detector 113 receives that control information from the operating system 100a and the relaying controller 111 ascertains that control information from the command detector 113. If the ascertained load control information indicates compulsory network change, the relaying controller 111 requests the operating system 100a to release connection of the wireless terminal 100 to the cellular network 11a and also commands the data transceiver 112 to change to another network, for example, the Wi-Fi network 11b for use. Even in the case that the control information indicating compulsory change of network in use is received from the command detector 113, the relaying controller 111 does not release connection to a network in use, for example, the cellular network 11a if another network is not available at present. In stead of releasing the current connection, the relaying controller 111 may start, as explained above, to receive another component (this may be an audio-only component) requiring the lowest bandwidth listed in the media index information that has been provided for a media content being currently received.

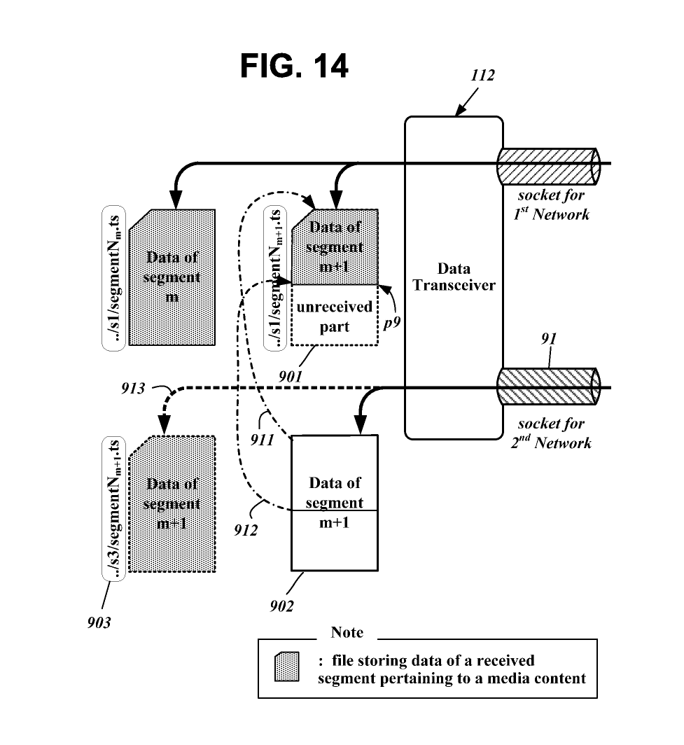

If there is a content segment 901 of which data is not entirely received through a previous network before network change as illustrated in FIG. 14 when network change is made during reception of a media content, the relaying controller 111 requests the partially-received segment 901 again through a changed network. At this time, information designating a network to use from now on may be provided to the data transceiver 112. According to the re-request, a socket 91 intended for using the changed network is created between the data transceiver 112 and the operating system 100a, and a request compliant with communication protocol demanding the content segment 901 of which data is partially received before is transmitted through the created socket 91. The response for the transmitted request including data of the re-requested segment 901 is received by the data transceiver 112 through the socket 91 and is then delivered 910 to the relaying controller 111 by the data transceiver 112. The relaying controller 111 stores data 902 of the content segment included in the received response in a corresponding file 901, which the received partial data of the segment has been stored in, from a suitable position 912 or again from the beginning position 911. In the former case, data corresponding to the unreceived part of the partially-received segment 901 is excerpted from data 902 of the re-received segment and is moved or copied into the location p9 next to the data stored last in the corresponding file before network change. In another embodiment according to the present invention, in the event that every content segment is accessible from its any position, the relaying controller 111 may transmit a request compliant with communication protocol demanding data of the partially-received segment 901 right from the receiving-stopped position p9 through the changed wireless network. In this case, data being received in response to the request is rightfully stored from the lastly-stored position p9 in the file 901 for the partially-received segment. If the local source information “. . . /s1/segmentNₘ₊₁.ts” for the partially-received content segment 901 is not provided to the media player 10b yet through an SgLI, the relaying controller 111 may store 913 data of the corresponding segment being received again through the changed wireless network as a separate file 903. A series of segments after the segment 901 are received through the changed network the same as those before the segment 901 were received through the previous network before network change. That is, the relaying controller 111 continues to request and receive segments sequentially based on continuously updated SgLI, edits the updated SgLI in such a manner that the source information for each segment listed thereon indicates a local repository where data of a corresponding segment is stored, and provides the edited SgLI to the media player 10b. And, the segments stored in individual repositories are successively delivered to the media player 10b in response to individual requests based on the SgLI provided to the media player 10b or are successively accessed by the media player 10b directly so that a live media content is continuously played.

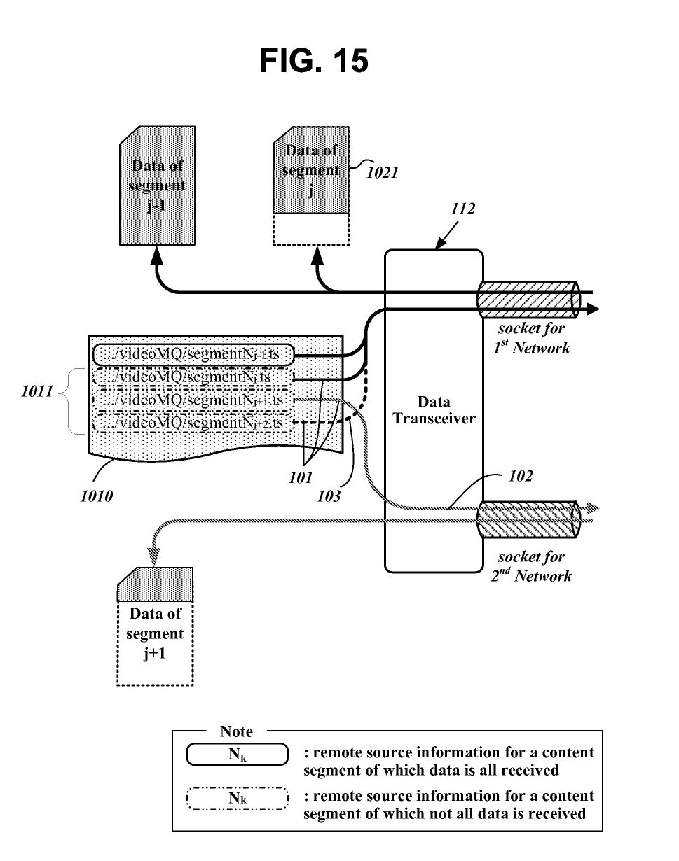

When using a plurality of wireless networks altogether, the relaying controller 111 delivers information designating a network for use to the data transceiver 112 as commanding the data transceiver 112 to transmit a request compliant with communication protocol demanding each content segment. For using multiple networks at the same time, it is premised that the operating system 100a is able to hold multiple access IPs, each of which is assigned from each of the multiple networks, for data communication. When using multiple networks jointly, the relaying controller 111 selects a network from among the multiple networks in a proper manner, for example, alternately 101 in order to use in requesting the not-yet received segments 1011 listed in the SgLI 1010 received from a remote site, as illustrated in FIG. 15. The proper selection is rightfully applied to later segments not listed in the SgLI 1010. If the relaying controller 111 commands the data transceiver 112 to transmit a request compliant with communication protocol demanding one of the not-yet received segments 1011 as delivering information to designate a network selected at this time, the data transceiver 112 transmits the request from the relaying controller 111 outwardly through the designated wireless network. Furthermore, even if there is a content segment of which data is not entirely received through the first network in case of using multiple networks jointly, the relaying controller 111 naturally requests 102 other segments after that segment through the second network. However, it does not request other segments after that segment through the first network. That is, if an arbitrary segment is not entirely received through a certain network, another segment following the arbitrary one is not requested through the same network. For example, if both of the j-th segment and the ‘j+2’-th segment are determined to be transmitted through the same network, the relaying controller 111 does not command 103 the data transceiver 112 to transmit a request for the ‘j+2’-th segment until the j-th segment 1021 is completely received, as illustrated in FIG. 15.

In one embodiment according to the present invention, multiple networks are used together for receiving a single content segment. In this case, the single segment is divided into several data blocks first, and requests for individual data blocks are transmitted distributively over the multiple networks. The data blocks received distributively over the multiple networks in response to the transmitted requests are combined to constitute a complete content segment. This method is also applicable to the case that a single network is used. Even if a single network is used physically, multiple sessions may be established over the single network for receiving a media content from a remote site. In such case, the divided data blocks of a single segment are requested and then received distributively through the individual multiple sessions.

In the meantime, the relaying controller 111 may command the data transceiver 112 to check current receiving bandwidth of each wireless network in case of using multiple networks together. The sum of bandwidths ascertained individually by the data transceiver 112 is compared with the demanding speed of a media content being received in order to know how much the receiving bandwidth is sufficient or lacks.

In one embodiment according to the present invention, not all the content segments listed in an SgLI, which is received by the relaying controller 111 in response to its own request, may be delivered to the media player 10b by the relaying controller 111. In other words, with respect to a segment or some segments listed in the SgLI received from a remote site, the relaying controller 111 may not receive them or may replace their source information with source information for another data object. According to this operation of the relaying controller 111, the SgLI provided to the media player 10b by the relaying controller 111 is what is partially deleted or replaced from the SgLI received from a remote site. In addition, the relaying controller 111 may deliver the media player 10b with a particular type of content additionally besides content segments listed in the SgLI received from a remote site. Even in this case, the media player 10b still keeps to conduct an operation only for playing a media content selected initially by itself without conducting any additional operation for inserting and processing the particular type of content, for example, an advertising or promotional video. For such insertion and playback of an additional content, the relaying controller 111 inserts, into the SgLI to be provided to the media player 10b, a new item that has not been listed in the SgLI received from a remote site.

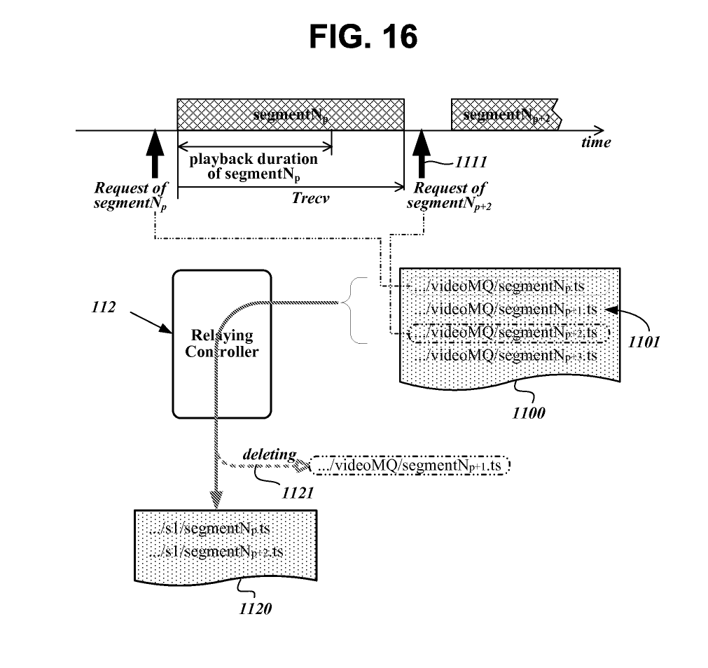

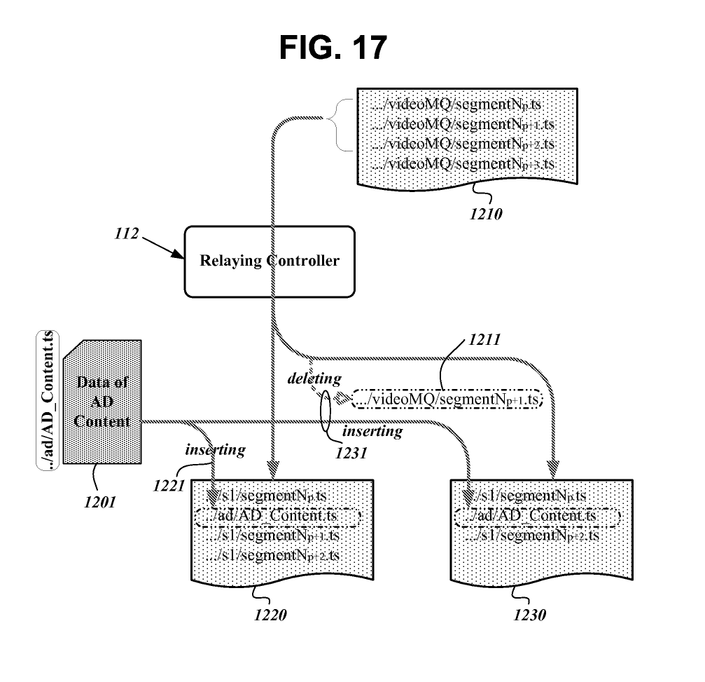

If the demanding speed of a media component being currently received is not supported by current communication state, a piece of source information, which has been included originally in an SgLI received from a remote site, may be deleted from an SgLI to be provided to the media player 10b. In the event that there is no component to select for degrade because the current component being received is lowest in quality (or is audio-only component), the relaying controller 111 skips a front content segment 1101, which has not requested now, and requests 1111 another segment right next to the skipped segment 1101, as illustrated in FIG. 16, if the current receiving bandwidth ascertained from the data transceiver 112 is lower than the demanding speed of the current component or if the time Trecv to be taken to receive an arbitrary content segment completely is longer than the playback duration of that arbitrary segment that is listed in the received SgLI. Of course, two or more content segments may be skipped according to the difference between the current receiving bandwidth and the demanding speed (or the difference between the time Trecv and the playback duration). In case of omitting an arbitrary content segment 1101 not to be received as described before, the relaying controller 111 deletes 1121 a piece of information about the omitted content segment 1101 from an SgLI 1120, which is drawn up based on the received SgLI from a remote site, to be provided to the media player 10b.

The relaying controller 111 may omit one or more content segments in the SgLI to be provided to the media player 10b in another certain situation. For example, the media player 10b would not take data of content segments over some time if it falls in a specific state, e.g., pause. Thus, if a situation where the media player 10b does not accept data through a local socket lasts longer than a preset times or over a pre-specified interval while the relaying controller 111 attempts to provide the media player 10b with a drawn-up response to request for a content segment received from the media player 10b through the local socket, the relaying controller 111 will omit one or more content segments, which are not yet requested to a remote site at present, in an SgLI to be prepared for providing to the media player 10b.

In case of providing a particular type of content, for example, advertising content for the media player 10b additionally besides a media content that has been requested and received by the media player 10b, the relaying controller 111 prepares an SgLI, which is to be provided to the media player 10b, in such a manner that information (source information and playback duration, etc.) for a content segment of the media content listed thereon is replaced or information about an advertising content is additionally inserted therein, as explained above. Such process is shown illustratively in FIG. 17. When preparing an SgLI from an original SgLI 1210 received from a remote site, the relaying controller 111 additionally inserts 1221 into the original SgLI local source information by which a file 1201 of already-received advertising data can be located (which results in an SgLI 1220), or replaces 1231 some information 1211 about a content segment with the local source information related with the advertising data file (which results in an SgLI 1230). If comparison of the demanding speed of the current media content with the receiving bandwidth measured by the data transceiver 112 reveals that the receiving bandwidth is sufficient for the demanding speed, the relaying controller 111 inserts 1221 the local source information of the advertising data file 1201 into an SgLI to be provided for the media player 10b. If the comparison reveals insufficient or if responses to requests for content segments from the media player 10b are not being delivered smoothly to the media player 10b, the relaying controller 111 replaces 1231 information about a content segment, which is preferably one of which no data is received yet, of a media content with the information (local source information and playback duration) about the advertising data file 1201.

In another embodiment according to the present invention, whether to just insert information about an advertising content or to replace information about a media content with information about an advertising content, with respect to an SgLI to be provided for the media player 10b, may be determined based on the playback duration of an advertising content to be additionally provided. If an advertising content was inserted in a live media content, the time to view scenes by the live media content would be delayed by the playback duration of the advertising content. Therefore, if the delay time to be caused from insertion of an additional content (i.e., playback duration of the additional content) is not longer than a predetermined interval, e.g., ten seconds, the relaying controller 111 replaces information about a content segment of a live media content. If longer, the relaying controller 111 just inserts information about the additional content in an SgLI to be provided for the media player 10b.

In the meantime, the relaying controller 111 obtains an advertising content in advance by accessing a pre-specified server periodically or at predetermined time zone. Alternatively, the relaying controller 111 may obtain an advertising content by referring to source information of the advertising content included in a response to a request for a remote media content that is originated at the media player 10b and is then relayed outwardly by the play agent 110 or 110′. In this case, the relaying controller 111 may delete source information about an advertising content from a received response when delivering the response to the media player 10b. The time when the local source information of an advertising content file is delivered to the media player 10b, namely, the time for an advertising content to be played may be determined in synchronization with a unit of time interval that is arbitrarily defined from beginning to deliver a media content, or determined based on information included in an SgLI being continuously updated from a remote site.

In the above-described embodiments, in the event that a particular type of content, e.g., an advertising content other than a media content selected by the media player 10b is inserted additionally or in replacing manner, the relaying controller 111 sets special information, e.g., a flag to indicate discontinuity of encoding time information (PCR, PTS) for a content segment (segmentNₚ₊₁ in an SgLI 1220 or segmentNₚ₊₂ in an SgLI 1230 in the example shown in FIG. 17) to be delivered right after the particular type of content. The special information setting is to prevent an error that could occur in decoding the media content after decoding of an advertising content in compliance with time information encoded therein because the media content is encoded with quite different time clock. An advertising content to be played in the middle of a media content may be provided with the discontinuity flag set. If not so, the relaying controller 111 conducts encoding operation to set the discontinuity flag in an advertising content to be inserted. In addition, when omitting source information about an arbitrary content segment of a selected media content as explained above, the relaying controller 111 may set the discontinuity flag in a content segment right following the omitted segment.

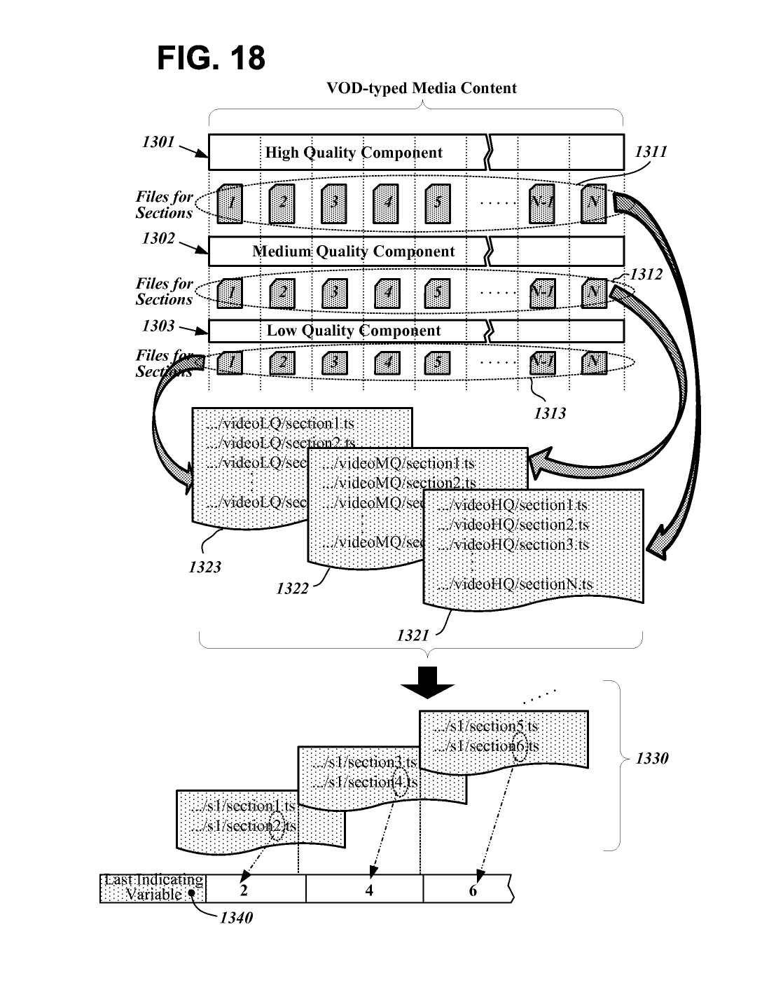

In the above explained embodiments according to the present invention, content data relaying in a wireless terminal was described in detail taking a live media content for example. A live media content means a content of which data is continuously created at present. Thus, its end position can not be determinable. When data is not created any more for a live media content, some data created lastly is organized into a content segment and an end indicator for informing “no more segments”, for example, “#EXT-X-ENDLIST” is written at source information about the last content segment to be listed in an SgLI. Therefore, if the end indicator is not included in an SgLI received from a remote site, the relaying controller 111 makes a request to a corresponding server for retransmission of an SgLI so that an SgLI may be updated to include newly created segments. If an SgLI is updated, the relaying controller 111 requests newly-created segments sequentially with reference to the updated SgLI. At this time, if the updated SgLI still lists a content segment having been requested based on a previous SgLI before update, information on that content segment is ignored. The concept and/or spirit of the present invention can be applied to a media content, whose full data is already prepared, such as a VOD (Video-On-Demand)-typed content (or each component pertaining to that type of content). For applying the present invention to such media, it should be premised that each component 1301, 1302 and 1303 pertaining to a VOD-typed media content has been divided into a plurality of sections by a server storing that media content, as illustrated in FIG. 18, and information about files 1311, 1312 or 1313, each containing data of a corresponding section, is provided through section list information (abbreviated to ‘ScLI’ hereinafter) as aforementioned. In this case, an ScLI 1321, 1322 or 1323 to be provided for a selected component by the server lists information (remote source information and playback duration, etc.) about all the sections pertaining to the selected component, and also contains an end indicator for informing “no more sections”. Accordingly, even if information about all sections is provided at a time in response to only single request for a corresponding component, the relaying controller 111 is able to still conduct equivalent of the aforementioned operations: grouping a few sections (a single section may belong to two adjacent groups in this section grouping) for adaptive quality change (component switching to other quality), or omitting or replacing a certain section every request from the media player 10b; drawing up an ScLI 1330 with information (local source information and playback duration, etc.) about each of the grouped sections; and delivering the drawn-up ScLI to the media player 10b. In this process, when an ScLI is requested from the media player 10b, the relaying controller 111 determines, based on the aforementioned LIV 1340, which sections are grouped to be delivered as a response to the media player 10b now. Of course, the response contains information such as local source information, etc. about the currently-grouped sections.

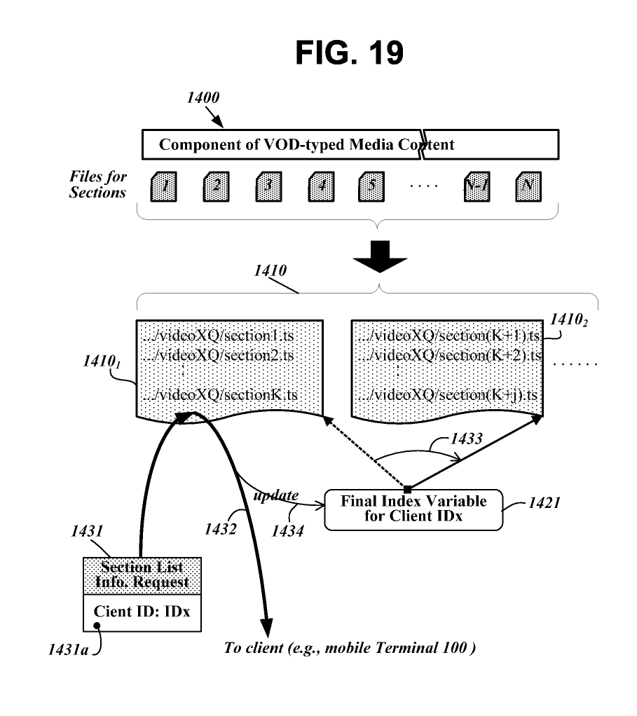

In another embodiment according to the present invention, a plurality of ScLIs 1410 may be prepared with respect to each component 1400 pertaining to a VOD-typed media content and each ScLI covers some sections, as illustrated in FIG. 19. In the event that a plurality of ScLIs are prepared for a single component of which data is already ready as shown in FIG. 19, a sever for providing a VOD-typed media content, for example, the content server 12 uses a “final index variable” 1421 in order to determine which ScLI is to be provided in response to an ScLI request from a wireless terminal. After the content server 12 transmits 1432 the first ScLI 1410₁ as a response when an ScLI request 1431 is received from a client, for example, the play agent 110 or 110′ of the wireless terminal 100, it updates 1434 value of the final index variable 1421 to indicate 1433 the next ScLI 1410₂. Afterwards, the content server 12 will transmit the ScLI indicated by the final index variable at the next ScLI request.

The value to be written in the final index variable 1421 may be a filename assigned to the first or the last section listed in a corresponding ScLI, a sequence number included in the filename, or a filename assigned to the corresponding ScLI. Unlike a live media content, a VOD-typed media content has not the constraint that the same part is viewed by participating clients at the same time. Accordingly, two or more ScLI requests received simultaneously by clients may demand mutually different parts of a corresponding content. For this reason, the content server 12 allocates the aforementioned final index variable for each of clients that requested the same media content. And, when requesting ScLI, the relaying controller 111 of the play agent 110 or 110′ puts, into a request as a value of a specific parameter, information 1431a to uniquely identify a client, for example, the wireless terminal 100, a user of the terminal 100, or the play agent 110 or 110′ (or the relaying controller 111). The information to uniquely identify the play agent 110 or 110′ may be a unique identification that is individually allocated to a counterpart on a session by the content server 12 while request and response in relation with a media content are made. When an ScLI request is received, the content server 12 searches for a final index variable allocated to client identifying information included in the received request, and determines, with reference to value of the found final index variable, which ScLI is to be transmitted to a corresponding client.

Unless the various embodiments, for the method of relaying media content by way of list information within a terminal, described so far are not compatible with each other, the explained embodiments can be properly chosen in various ways and then combined to achieve the concept and idea of said relaying method.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

1. A terminal being capable of receiving data of a media content through a wireless network, comprising:
a transceiver configured to transceive data to/from an external server through a wireless network;
a storage unit configured to store data of a media content received from a remote site through the transceiver; and
a controller configured to
request list information of content sections through the transceiver and receive the list information from a remote site, the content sections pertaining to a media content selected by an arbitrary entity being executed in the terminal,
request sections of the selected media content based on the received list information and store the requested sections in the storage unit while receiving the sections from a remote site through the transceiver, and
prepare list information for all or a part of content sections listed in the received list information, if a request for list information is received from another entity with respect to the selected media content, and provide the prepared list information to the another entity as a response to the received request,
wherein the controller prepares the list information from information included in the received list information in such a manner that remote source information about a content section listed in the received list information is changed to local source information including a file pathname assigned to a repository allocated for storing data of the content section in the storage unit.

2. The terminal of claim 1, wherein the controller is configured to change the remote source information to local source information in which information to identify, based on IP address system, an entity being executed in the terminal is located before a file pathname.

3. The terminal of claim 2, further comprising a delivering unit configured to:
read data stored in a specific repository if a request for a content section based on IP address system is received from the another entity, the specific repository being identified by a file pathname included in the request for a content section or by repository information associated with the file pathname;
incorporate the read data into a response to the received request for a content section; and
provide the response to the another entity.

4. The terminal of claim 2, wherein the file pathname assigned to the repository is a pathname to uniquely identify the repository under file system that works in the terminal, or a pathname that is assigned pursuant to the file system but does not indicate the repository directly.

5. The terminal of claim 1, wherein the controller is configured to change the remote source information to local source information including:
information to uniquely identify, under file system that works in the terminal, a file of content section allocated in the storage unit and to direct access of the file; or information to indicate a repository of content section under a pre-specified rule and information to specify that the local source information is pursuant to the pre-specified rule.

6. The terminal of claim 1, wherein a request for the selected media content is delivered from the arbitrary entity to the controller through a local socket of which destination is set to an internal address, and the local socket is created according to the request for the selected media content in such a manner that destination thereof is set to the internal address, irrespective of destination address written in the request for the selected media content, that is registered in proxy information configured for the terminal.

7. (canceled)

8. The terminal of claim 1, wherein the controller is configured to:
receive list information for content sections through successive requests or only single request with respect to each of components of mutually different qualities of attributes that belong to the selected media content;
change from a component being currently received to another component for the selected media content if a specific condition is satisfied; and
receive content sections pertaining to the changed another component.

9. The terminal of claim 8, wherein the controller is configured to:
prepare new list information to include local source information for content sections that are received for the another component, even if list information for a component initially chosen for the selected media content is requested from the another entity after the component change; and
provide the new list information to the another entity in response to the list information request after the component change.

10. The terminal of claim 8, wherein the specific condition includes at least one of:
a condition that a type of a wireless network to which the wireless terminal is connected corresponds to a predetermined particular type of network;
a condition that network change is made between networks that charge different data service fee each other on premise of same amount of data usage;
a condition that a ratio of demanding speed of a component being currently received to receiving bandwidth supported by current communication state is greater than a first reference or smaller than a second reference;
a condition that an amount of data used with respect to a particular wireless network through the terminal or on behalf of a subscriber of the terminal exceeds a preset amount of data; and
a condition that control information to restrict using a particular wireless network is received from an outside.

11. The terminal of claim 1, wherein the controller is further configured to:
relay a request for the selected media content from the arbitrary entity to a remote site through the transceiver;
select a single component from among a plurality of components listed in media index information that is received through the transceiver from the remote site in response to the relayed request;
prepare media index information to list the selected single component and provide the prepared media index information for the arbitrary entity or the another entity.

12. (canceled)

13. The terminal of claim 11, wherein the controller is further configured to select the single component based on which type of wireless network is currently connected to the terminal.

14. (canceled)

15. The terminal of claim 1, wherein the controller is configured to: check, in case bit rate of the media content being received from the remote site is to be lowered, whether another wireless network is connectable;
and switch, if connectable, connection of the terminal to the another wireless network.

16. The terminal of claim 1, wherein the controller is further configured to:
check, in case information to limit a traffic load applied to a wireless network being currently used by the terminal is received from an outside, whether another wireless network is connectable;
switch, if connectable, connection of the terminal to the another wireless network; and
lower, if not connectable, bit rate of the media content being received from the remote site before requesting sections of the media content.

17. The terminal of claim 1, wherein the controller is configured to:
prepare one or more pieces of list information by modifying information about content sections listed in the received list information; and
provide the prepared one or more pieces of list information individually in response to a list information request from the another entity,
wherein in providing the prepared one or more pieces of list information, the controller omits information about at least one content section listed in the received list information not to be provided to the another entity, replaces the information about the at lease one content section with information about another media object, or adds the information about the another media object into the prepared list information.

18. The terminal of claim 17, wherein the controller is configured to conduct the omitting or the replacing based on a result of comparing receiving bandwidth pursuant to current communication state with demanding speed of content sections being currently received or based on a state in which a response to a content section request pursuant to list information provided to the another entity is delivered to the another entity.

19. The terminal of claim 17, wherein the controller is configured to determine, based on how much playing the media content will be delayed due to the another media object, whether to replace the information about the at lease one content section with the information about the another media object or to add the information about the another media object into the prepared list information.

20.-21. (canceled)

22. The terminal of claim 1, wherein the selected media content is a live media content having a data section whose data is created in real time, or a media content of which every section is already prepared with its data.

23. (canceled)

24. The terminal of claim 1, wherein both the another entity and the arbitrary entity are same entity.

25. The terminal of claim 1, wherein both the another entity and the arbitrary entity are separate entities that are executable independently each other, and wherein the controller is configured to:
request the selected media content to a remote site according to information carried by a request for the selected media content received from the arbitrary entity;
receive a response including information about at least one component pertaining to the requested media content; and
provide the received response including the information about the at least one component as a response to a request for the selected media content received from the another entity.

26. A method for having a media content received from a remote site and played in a terminal, comprising:
receiving information about a media content selected by an arbitrary entity being executed in the terminal;
requesting list information of content sections pertaining to the selected media content based on the received information about the media content, and receiving the requested list information through a wireless network; and
conducting a first operation for obtaining a content section listed in the received list information from an external server and a second operation for providing list information drawn up based on the received list information to another entity,
wherein the first operation comprises
requesting, with reference to remote source information on a content section listed in the received list information, the external server to transmit the content section, and
storing data of the content section that is received accordingly,
and wherein the second operation comprises
drawing up list information for all or a part of content sections listed in the received list information according to a request for list information received from the another entity with respect to the selected media content, and
providing the drawn-up list information to the another entity as a response to the request received from the another entity
wherein the list information is drawn up in such a manner that remote source information about an arbitrary content section listed in the received list information is changed to local source information including a file pathname assigned to a repository allocated for the arbitrary content section.

27. An apparatus for providing a program stored in a storage, comprising:
communication means being capable of transceiving data with an outside entity; and
a storing unit storing an application, to be run on a wireless terminal, that is transmitted through the communication means,
wherein the application includes program structures to accomplish functions, in case of being run on the wireless terminal, that comprise:
a first function of requesting list information of content sections pertaining to a media content, selected by an arbitrary entity being executed in the wireless terminal, to an external server and receiving the list information therefrom;
a second function of requesting, based on information about a content section listed in the received list information, content sections to an external server and storing the content sections received therefrom as individual files;
a third function of preparing list information for all or a part of content sections listed in the received list information if a request for list information is received from another entity with respect to the selected media content, and providing the prepared list information to the another entity as a response to the received request,
wherein the list information is prepared in the third function in such a manner that remote source information about an arbitrary content section listed in the received list information is changed to local source information including a file pathname assigned to a repository allocated for the arbitrary content section.
